(19) United States
(12) Patent Application Publication
(10) Pub. No.: US 2014/0114715 A1
(43) Pub. Date: Apr. 24, 2014

(54) SYSTEMS AND METHODS FOR MANAGING REQUESTS

(71) Applicant: Sarah Clark KAVANAGH, Bethesda, MD (US)

(72) Inventors: Sarah Clark KAVANAGH, Bethesda, MD (US); Filip POPOVIC, San Francisco, CA (US)

(73) Assignee: Sarah Clark Kavanagh, Bethesda, MD (US)

(21) Appl. No.: 14/030,804

(22) Filed: Sep. 18, 2013

Related U.S. Application Data
(60) Provisional application No. 61/702,622, filed on Sep. 18, 2012.
(60) Provisional application No. 61/710,281, filed on Oct. 5, 2012.

(51) Int. Cl. G06Q 10/06

(52) U.S. Cl. CPC G06Q 10/063114
USPC 705/7.15

(57) ABSTRACT

A computer-based method and system for managing work requests, said method comprising: generating a work request based on a user input; storing an assignment of the work request to a responder based on the user input; and tracking and storing, at the computing device, progress of the work request such that the progress of stored work requests may be reviewed.

### CROSS-REFERENCE TO RELATED APPLICATIONS

This application claim priority to U.S. Provisional Application Nos. 61/702,622, filed Sep. 18, 2012 and 61/710,281 filed Oct. 5, 2012, which are incorporated by reference in their entireties.

This application is also related to U.S. patent application Ser. No. 13/589,803, filed Aug. 20, 2012, which is incorporated by reference in its entirety.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a block diagram of an example computing device.

FIG. 2 is a block diagram of a research request system according to one embodiment of the present disclosure.

FIG. 3 is an example administrator dashboard user interface for an administrator that may be used with the research request system shown in FIG. 2.

FIG. 4 is an example reassign interface that may be used with the research request system shown in FIG. 2.

FIGS. 5 and 6 are an example knowledge base creation interface that may be used with the research request system shown in FIG. 2.

FIG. 7 is an example knowledge base search results interface that may be used with the research request system shown in FIG. 2.

FIG. 8 is an example advanced knowledge base search interface that may be used with the research request system shown in FIG. 2.

FIG. 9 is an example view knowledge base interface that may be used with the research request system shown in FIG. 2.

FIG. 10 is an example modify knowledge base interface that may be used with the research request system shown in FIG. 2.

FIG. 11 is an example request type setup interface that may be used with the research request system shown in FIG. 2.

FIG. 12 is an example custom fields configuration interface that may be used with the research request system shown in FIG. 2.

FIG. 13 is an example create request type interface that may be used with the research request system shown in FIG. 2.

FIG. 14 is an example system settings interface with an app settings tab selected that may be used with the research request system shown in FIG. 2.

FIG. 15 is an example email template modification interface that may be used with the research request system shown in FIG. 2.

FIG. 16 is an example system settings interface with a task description tab selected that may be used with the research request system shown in FIG. 2.

FIG. 17 is an example system settings interface with a tags tab selected that may be used with the research request system shown in FIG. 2.

FIG. 18 is an example user alerts interface with a responder alerts tab selected that may be used with the research request system shown in FIG. 2.

FIG. 19 is an example user alerts interface with a requestor alerts tab selected that may be used with the research request system shown in FIG. 2.

FIG. 20 is an example time sheet interface that may be used with the research request system shown in FIG. 2.

FIG. 21 is an example responder dashboard interface that may be used with the research request system shown in FIG. 2.

FIG. 22 is an example view request interface with a data tab selected that may be used with the research request system shown in FIG. 2.

FIG. 23 is an example view request interface with a history tab selected that may be used with the research request system shown in FIG. 2.

FIG. 24 is an example view request interface with a description tab selected that may be used with the research request system shown in FIG. 2.

FIG. 25 is an example time track interface that may be used with the research request system shown in FIG. 2.

FIG. 26 is an example requestor dashboard interface that may be used with the research request system shown in FIG. 2.

FIG. 27 is an example reply interface that may be used with the research request system shown in FIG. 2.

FIG. 28 is an example feedback interface that may be used with the research request system shown in FIG. 2.

FIGS. 29-31 are an alternative example system settings interface that may be used with the research request system shown in FIG. 2.

FIG. 32 is an example administrator dashboard interface that may be used with the research request system shown in FIG. 2.

FIG. 33 is an example create request interface that may be used with the research request system shown in FIG. 2.

FIG. 34 is an alternative create request interface that may be used with the research request system shown in FIG. 2.

FIG. 35 is an example user settings interface that may be used with the research request system shown in FIG. 2.

FIG. 36 is an example create quick time track interface that may be used with the research request system shown in FIG. 2.

FIG. 37 is an example request answer interface that may be used with the research request system shown in FIG. 2.

FIG. 38 is an example responder dashboard interface illustrating a quick time track feature that may be used with the research request system shown in FIG. 2.

FIG. 39 is an example request settings interface that may be used with the research request system shown in FIG. 2.

FIG. 40 is list of example recommended fields.

FIG. 41 is a list of example recommended request types.

FIGS. 42A-42C is a list of example tags.

FIG. 43 is a list of time track custom fields.

### DETAILED DESCRIPTION

The present disclosure relates generally to systems and methods for managing work requests of any kind. The system described herein may be used for any position where requests to perform work are given to individuals to perform and where saving information/data for later use will be beneficial. Such positions include, but are not limited to, positions in the following fields: consulting, legal, marketing, government, media, financial services, banking, research and development (e.g., public sector, academia, government-sponsored), or sales, or any combination thereof.

While all types of work are covered by the present disclosure, the example of managing research requests using a research request management application is utilized to demonstrate aspects of embodiments of the invention. In some embodiments, the research request management application is hosted by a research request server or another server to provide user interfaces to a research requestor, a research responder (e.g., a researcher), an administrator, or another user to facilitate generating, tracking, and completing one or more research requests.

Research may be performed through use of one or more resources, including, without limitation, books, periodicals, online databases, web search engines, etc. In general, the topic selected for research indicates one or more types of resources particularly suited for the research. For example, legal research is known to involve the review of court decisions through use of case reporters, treatises, and/or online legal research, such as the Westlaw® research website and the LexisNexis® research website.

In general, research is performed by a first individual in response to a request by a second individual. Such a request may be formal, informal, electronic (e.g., sent via email), verbal, and/or written. Further, the request may, for example, be limited to research using specified research sources, may need to be completed by a specified date, and/or may be limited to a particular subject matter field. Accordingly, different research requests may be issued in significantly different formats and require significantly different criteria for proper completion. For businesses that constantly generate and complete a relatively large number of research requests (e.g., law firms), it would be desirable to be able to create, modify, and track research requests in a comprehensive, uniform way.

Example technical effects of the methods and systems described herein may include at least one of (a) generating a research request based on a user input; (b) generating a knowledge base based on the user input; (c) storing an association between the research request and the knowledge base based on the user input; (d) storing an assignment of the research request to a responder based on the user input; and (e) tracking, a status of the research request (e.g., inputting and/or monitoring time spent completing the research request).

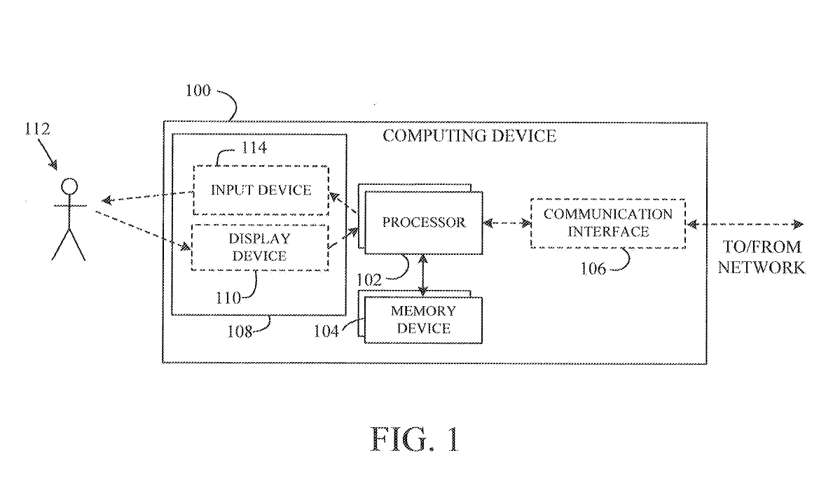

FIG. 1 illustrates an example computing device 100. In the example embodiment, computing device 100 may include a memory device 104 and a processor 102 (e.g., processing device) coupled to memory device 104. In some embodiments, executable instructions are stored in memory device 104 and executed by processor 102. Computing device 100 is configurable to perform one or more operations described herein by programming and/or configuring processor 102. For example, processor 102 may be programmed by encoding an operation as one or more executable instructions and providing the executable instructions in memory device 104.

Memory device 104 may be one or more devices operable to enable information such as executable instructions and/or other data to be stored and/or retrieved. Memory device 104 may include one or more computer readable media, such as, without limitation, hard disk storage, optical drive/disk storage, removable disk storage, flash memory, non-volatile memory, ROM, EEPROM, random access memory (RAM), etc. Memory device 104 may be configured to store, without limitation, computer-executable instructions, transmitter identifiers, account identifiers, payment account information, and/or any other type of data. Memory device 104 may be incorporated in and/or separate from processor 102.

Processor 102 may include one or more processing units (e.g., in a multi-core configuration). The term processor, as used herein, refers to central processing units, microprocessors, microcontrollers, reduced instruction set circuits (RISC), application specific integrated circuits (ASIC), logic circuits, and any other circuit or processor capable of executing instructions to perform functions described herein.

Computing device 100 may include a communication interface 106 coupled to processor 102. Communication interface 106 may be configured to be coupled in communication with one or more other devices, such as another computing device 100, a network, etc. Communication interface 106 may include, without limitation, a serial communication adapter, a wired network adapter, a wireless network adapter, a mobile telecommunications adapter, a radio frequency (RF) receiver, a radio frequency identification (RFID) reader, and/or any other device capable of communicating with one or more other devices. Communication interface 106 may transmit information to and/or receive information from one or more other computing devices 100.

In this example embodiment, computing device 100 may include a user interface 108 to interact with user 112, such as an administrator, a research requestor, and/or a research responder. As used herein, a research requestor may be an entity and/or individual that generates a research request, and a research responder may be an entity and/or individual responsible for completing a research request. As illustrated, user interface 108 includes a display device 110. Display device 110 may include, for example, a cathode ray tube (CRT), a liquid crystal display (LCD), an LED display, an organic LED (OLED) display, an “electronic ink” display, and/or other device suitable to display information. Additionally, or alternatively, user interface 108 may include an audio output device (e.g., an audio adapter, a speaker, etc.).

User interface 108 may include an input device 114 to receive one or more inputs from user 112. Input device 114 may include, without limitation, a button, a knob, a keypad, a pointing device, a mouse, a touch sensitive panel (e.g. a touch pad or a touchscreen), a gyroscope, a position detector, and/or an audio input (e.g., a microphone). In various embodiments, user interface 108 may include a single component, such as a touchscreen display, incorporating both display device 110 and input device 114.

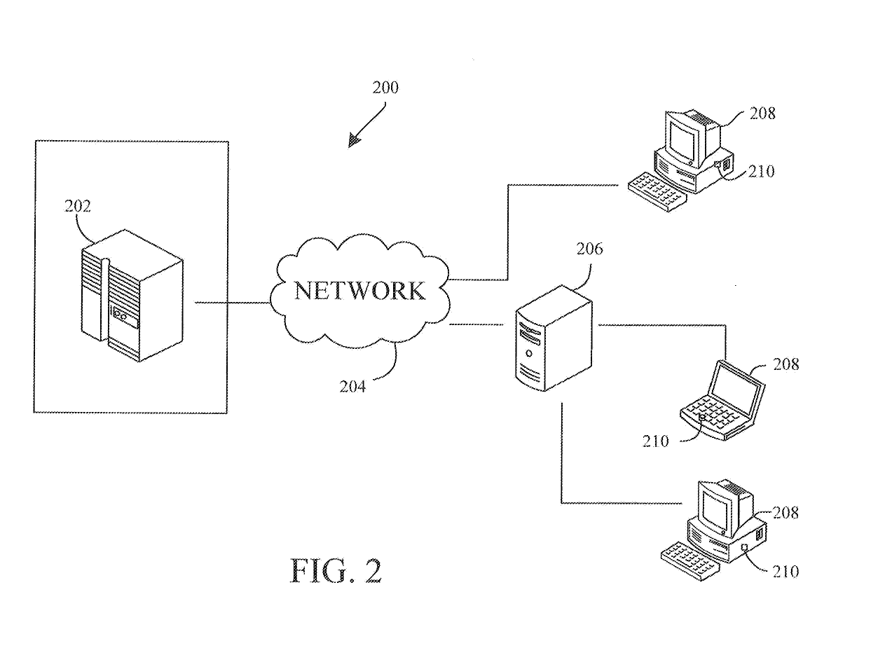

FIG. 2 illustrates an example research request system 200 for use in managing research requests. Research request system 200 may include a research request server 202 coupled to a network 204. Network 204 may include, without limitation, the Internet, an intranet, a local area network (LAN), a cellular network, a mobile network, and/or a wide area network (WAN), etc. Research request system 200 may be employed to manage research requests for various types of research, including, without limitation, legal research, business research, medical research, financial research, and/or news research, etc. In the example embodiment, research request system 200 may include a client server 206 on the premises of an entity and multiple client workstations 208 associated with the entity, either on the premises of the entity or remotely situated, while being accessible to a user associated with the entity. In the example embodiment, the entity is described as a law firm, using the research request system 200 to manage legal research requests. It should be appreciated that other entities, such as companies, firms, association, corporations, etc., may employ the research applications described herein to perform a variety of different types of research.

Workstations 208 may be connected to network 204, directly or indirectly through client server 206, as illustrated in FIG. 2. Workstations 208 may include, without limitation, a computer, a laptop, a desktop, a personal digital assistant (PDA), a smartphone, or other device suitable to perform as described herein. As should be apparent, client servers and/or workstations may be situated elsewhere in other research system embodiments. It should be appreciated that research request server 202, client server 206 and workstations 208 are examples of computing devices 100.

Research request server 202 may be configured to provide a research request management application, including multiple user interfaces, for use by a user at workstation 208. In this example embodiment, the research request management application may be substantially hosted by research request server 202. It should be appreciated that the research request management application may be hosted at research request server 202, client server 206 and/or workstation 208 in other research request system embodiments. More specifically, the research request management application may be include any suitable application hosted and/or executed from one or more of research request server 202, client server 206, and workstation 208. In one example, research request management application may be hosted and executed on workstation 208, such that network 204 and/or servers 202 and 206 may be omitted. In such examples, client server 206 and/or workstation 208 are configured appropriately to host and/or execute various functions associated with the research request management application, as described herein. Such configuration may include meeting certain software requirements, such that computing devices 100 includes a LAMP package (Linux, Apache. MySQL, PHP) along with JDK (Java Development Kit).

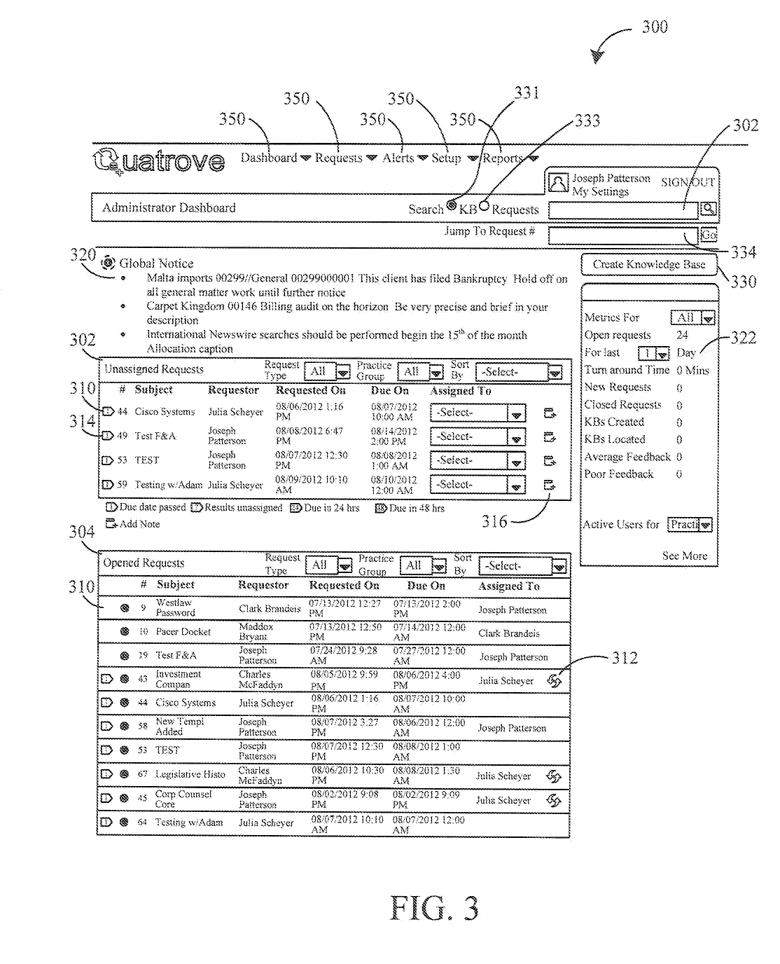

FIGS. 3-32 illustrate multiple user interfaces of the example research request management application. Each of the interfaces may be provided from research request server 202 for presentation to the user 112 at one or more workstations 208. In the example embodiment, the research request management application may include a research request website accessible at workstations 208 by a web browser, such as Internet Explorer, Firefox, Google Chrome, Safari, etc. It should be appreciated, however, that the research request management applications described herein may include various types of applications and/or programs, and thus are not limited to websites and/or web pages provided by research request server 202 for presentation to the user 112 at workstation 208. For example, the research request management application may include an application executed by client server 206 and/or workstation 208 local to the law firm, such that websites and/or web pages may be omitted. Further, in several embodiments, the research request management application may be divided among research request server 202, client server 206 and/or 208, such that any portion of the interfaces of the research request management application, including none, are provided through network 204.

In this example embodiment, each workstation 208 may include a research request connector 210. Research request connector 210 may be configured to interact with the research request management application to host and/or overlay one or more web browsers, as described herein. It should be appreciated that research request connector 210 may be integrated with research request management application and/or omitted in other research request management system embodiments.

The research request management application may include numerous user interfaces provided from research request server 202 for presentation at workstation 208. The number and type of user interfaces accessible by a user of workstation 208 may be based on the type of research to be performed and/or the type of user accessing the research request management application. In the example embodiment, user 112 may include an administrator (e.g., a librarian. IT professional), a research requestor or research responder (e.g., an attorney, paralegal, reporter, financial analyst), or other individual involved in management and/or use of research requests. In one example, an administrator may have access to a variety of user interfaces to affect various setup, control, alert, and/or reporting options, while a researcher's access may be limited to user interfaces associated with creating, viewing, and/or managing research requests. In various embodiments, research request server 202 may receive a credential from the user 112, prior to permitting access to one or more user interfaces. In at least one embodiment, the credential presented by a user 112 (e.g., a username and a password) and received by research request server 202 may automatically designate the user 112 as an administrator, researcher, or other type of user.

Research request management application manages a plurality of research requests. Within research request management application, a requestor may generate a research request. The generated research request may be assigned to a responder who is responsible for completing the research request. Additionally, research requests may be organized into one or more knowledge bases, as described in more detail below. Upon accessing the research request management application, research request server 202 may provide a dashboard interface for presentation to the user 112 at workstation 208.

One example dashboard interface 300 for an administrator user 112 is illustrated in FIG. 3. As used herein, an administrator may perform administrative tasks (e.g., assigning research requests, analyzing metrics, controlling setup/configuration of the research request management application), a requestor may generate one or more research requests, and a responder may be responsible for completing one or more research requests. User 112 may operate research request management application as an administrator, a requestor, and/or a responder.

Dashboard interface 300 includes an unassigned requests list 302 and an open requests list 304. As shown in FIG. 3, unassigned requests list 302 and open requests list 304 may each include a plurality of research requests 310. Each research request 310 may be identified by various descriptors. In the example embodiment, each research request 310 may be identified by a request number, a subject (i.e., what the research request 310 is related to), a requestor (i.e., who generated the research request 310), a requested-on date (i.e., the date the research request 310 was generated), a request due date, and who the research request 310 is assigned to (i.e., who is responsible for completing the research request 310). If a research request 310 is unassigned, it appears on unassigned requests list 302. The administrator user 112 can then assign the request by selecting a responder using, for example, a drop down menu. The responder may be the person responsible for completing the research request 310. Once a research request 310 has been assigned, the research request 310 may appear on the open requests list 304 until it has been completed. By selecting a reassign button 312, an assigned research request 310 can be reassigned to a different responder.

Research requests 310 may also include one or more indicators 314. In the example embodiment, indicators 314 may indicate a due date has passed, a request 310 is unassigned, a research request 310 is due in 24 hours, and/or a research request 310 is due in 48 hours. Alternatively, any suitable information concerning requests 310 may be indicated using indicators 314. In the example embodiment, requests 310 in unassigned requests list 302 may include an add note button 316 that enables the user 112 to add a note to a particular research request 310.

Dashboard interface 300 enables user 112 to sort research requests 310 by selecting a sort parameter from a drop-down menu. Sort parameters may include subject, requestor, responder, and/or any other descriptor of the research requests 310. Further, using associated drop-down menus, user 112 can filter unassigned requests list 302 and open requests list 304 to display only requests 310 of a certain type or requests 310 associated with a particular practice group.

In the example embodiment, dashboard interface 300 includes a global alerts panel 320 that includes global alerts (e.g., alerts, tips, and/or notices) for users 112 of the research request management application. In the example embodiment, global alerts in global alerts panel 320 may be separate from user alerts generated using a user alerts interface, as described in detail below. Global alerts that appear in global alerts panel 320 may be associated with a particular client, a particular matter, or be unrelated to a client and/or matter. Dashboard interface 300 also includes a metrics panel 322 that displays a plurality of metrics, such as new requests, knowledge bases created, etc. Metrics displayed on metrics panel 322 may be filtered using drop-down menus. Although in the example embodiment of research application, certain features may be implemented using a particular menu device (e.g., drop-down menu, text entry field, radio buttons, etc.), those of ordinary skill in the art will appreciate that any suitable menu device may be used to implement features of the research request management application.

Dashboard interface 300 may include a create knowledge base button 330 that enables user 112 to create a new knowledge base, as described in more detail below. Further, user 112 can search for an existing knowledge base by selecting a knowledge base radio button 331 and using a search field 332, or search for an existing research request by selecting a research request radio button 333 and using the search field 332. User 112 can also quickly jump to a particular research request 310 by entering an associated request number in a jump to request field 334.

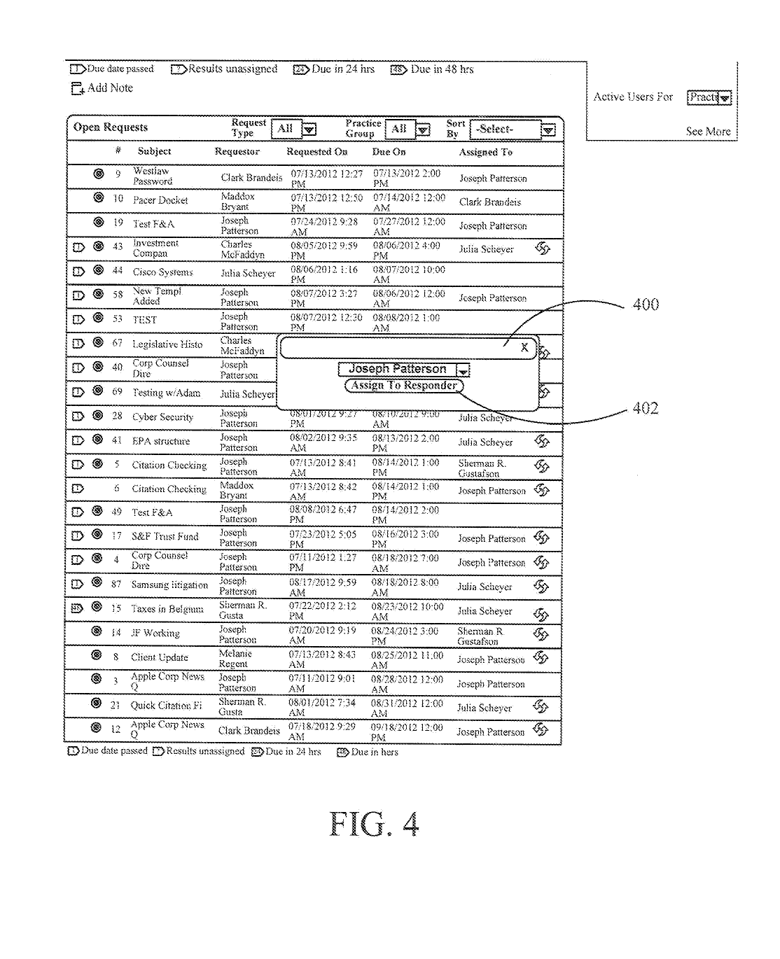

When the administrative user 112 selects reassign button 312, a reassign interface 400 may be displayed, as shown in FIG. 4. Reassign interface 400 may enable the user to select the new responder using a drop-down menu. By selecting an assign to responder button 402, the research request 310 may be reassigned to the selected responder.

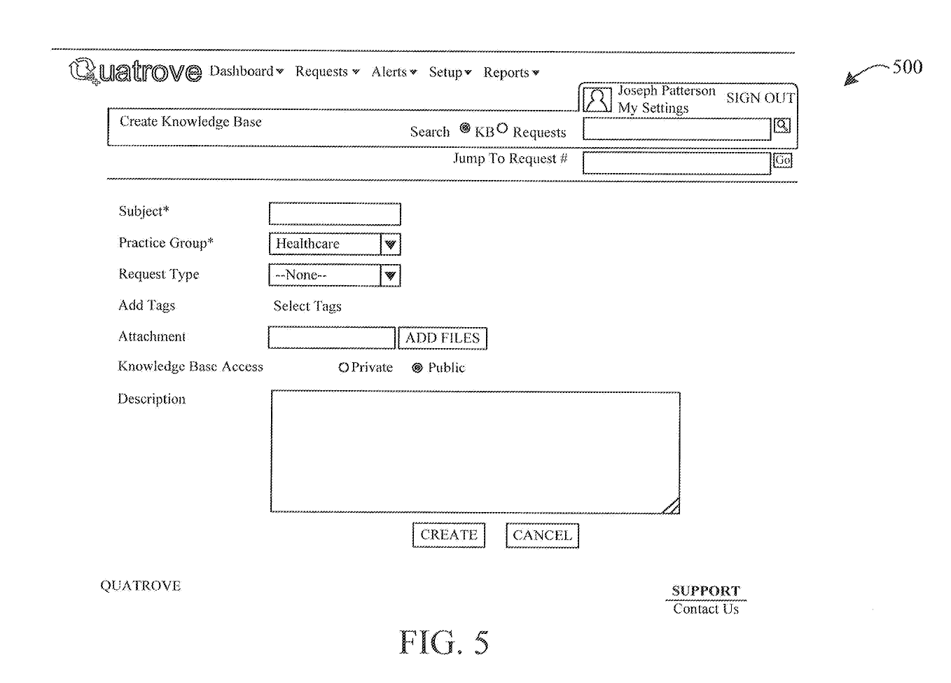

When the create knowledge base button 330 is selected, research request server 202 may provide an example knowledge base creation interface 500, as shown in FIG. 5. In the example embodiment, administrators may be able to create new knowledge bases, and responders may be able to create new knowledge bases if given authorization from an administrator to do so.

Knowledge base creation interface 500 may include several fields that enable the user 112 to create a new knowledge base. In the example embodiment, the user 112 can specify a subject, practice group, and request type for the knowledge base. A description of the knowledge base may also be provided by the user 112, and the user 112 may attach one or more files to the knowledge base.

In the example embodiment, knowledge base creation interface 500 may include radio buttons enabling the user 112 to specify whether access to the created knowledge base is public or private. If access to the knowledge base is private, the created knowledge base may be only visible to administrators and responders inside the firm (i.e., the research team). If access to the knowledge base is public, the created knowledge base may be visible to everyone at the law firm who uses the research request management application.

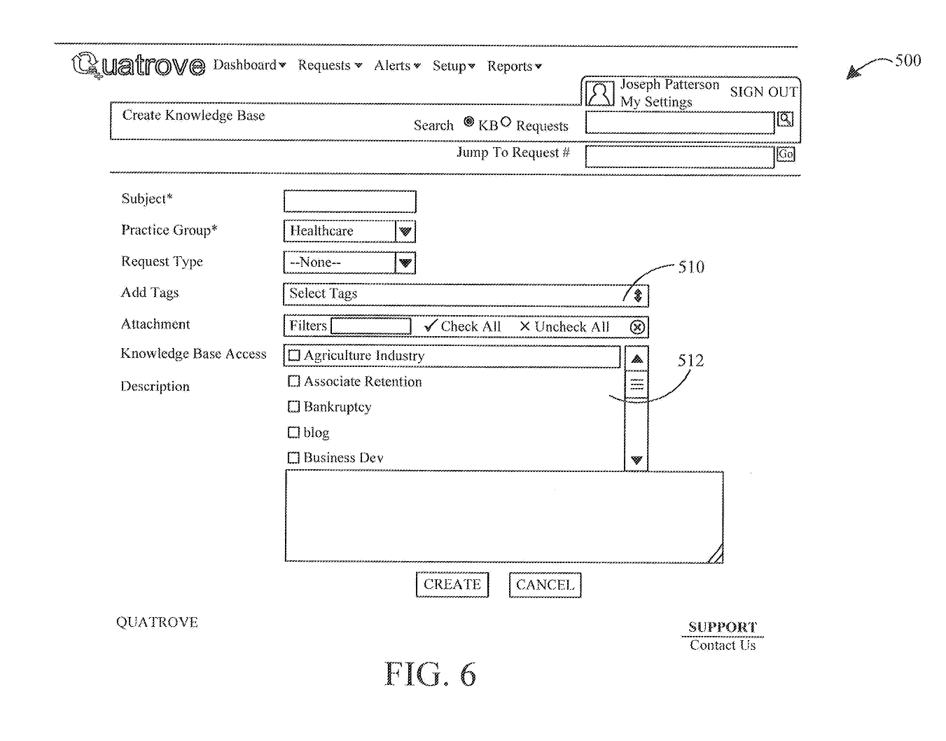

The user 112 can also add one or more tags to the knowledge base using knowledge base creation interface 500 in the example embodiment, as shown in FIG. 6. When selecting an add tag field 510, a tag selection window 512 may be generated by research request server 202. Tag selection window 512 may enable the user 112 to select one or more tags to be added to the knowledge base. Each tag may be a label attached to the created knowledge base for identification or other information.

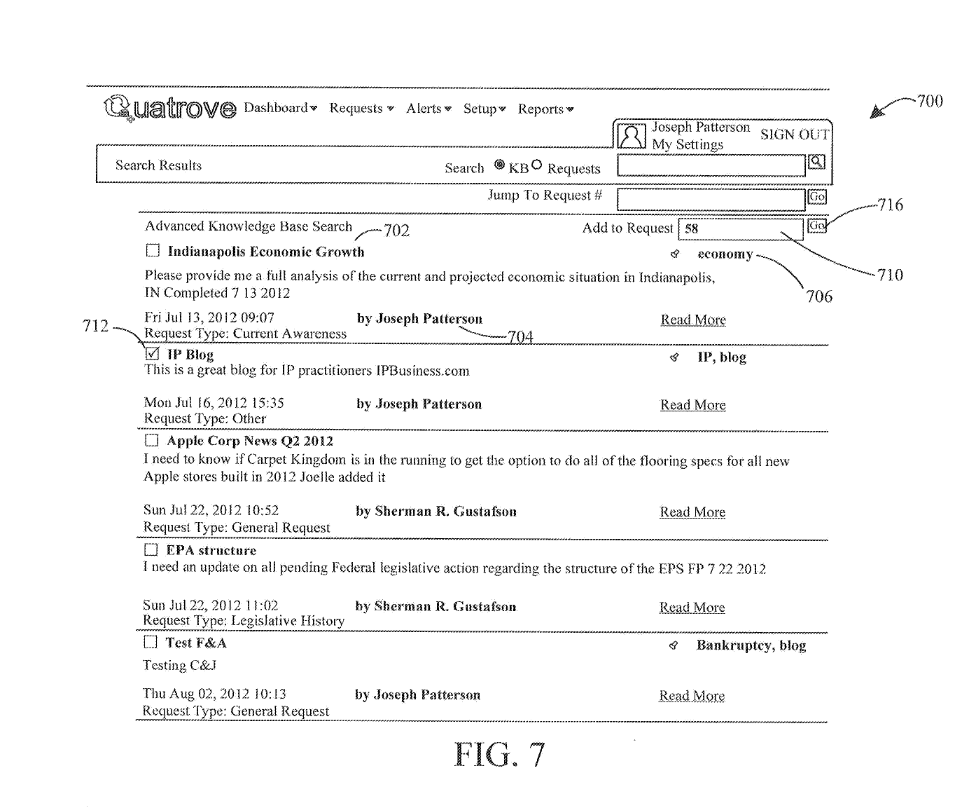

When user 112 searches for a knowledge base by selecting knowledge base radio button 331 and using search field 332 (both shown in FIG. 3), research request server 202 may generate a knowledge base search results interface 700, as shown in FIG. 7. Search results interface 700 displays a list of knowledge bases. In the example embodiment, each listed knowledge base includes the knowledge base name 702, the creator of the knowledge base 704, and any tags 706 associated with the knowledge base. When the user 112 selects research request radio button 333 and uses search field 332, research request server 202 may generate a research request search results interface (not shown) that operates substantially similar to knowledge base search results interface 700 to search for research requests, as opposed to knowledge bases.

A research request 310 may be added to a particular knowledge base using an add to request field 710. Specifically, in the example embodiment, when a user 112 checks a knowledge field selection box 712, enters a research request number in add to request field 710, and selects a go button 716, the identified research request 310 may be added to the selected knowledge base.

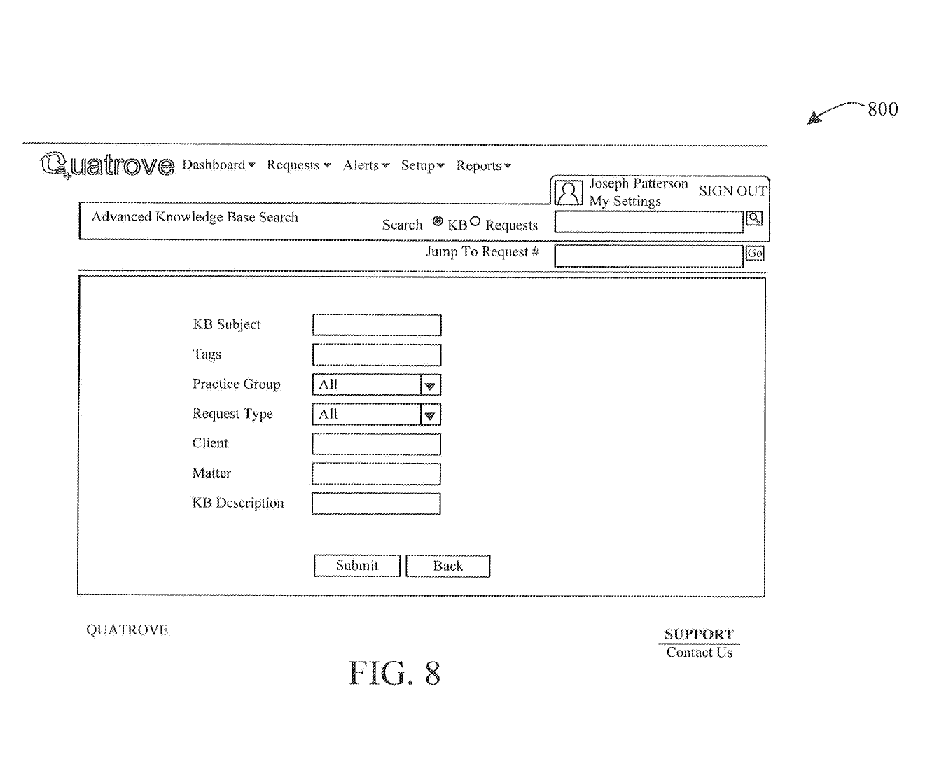

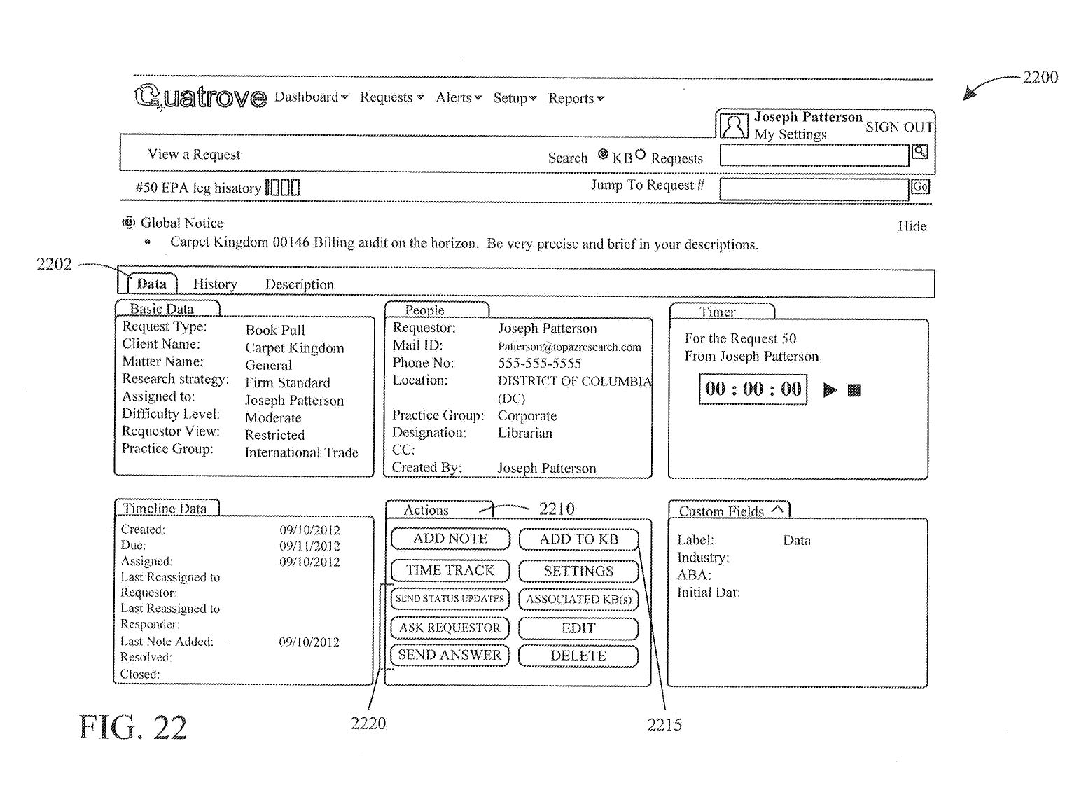

The user 112 may also use an advanced knowledge base search interface 800, as shown in FIG. 8, to search for a particular knowledge base. Advanced knowledge base search interface 800 may enable user 112 to search for knowledge bases by subject, tags, practice group, request type, client, matter, and/or description. In the example embodiment, the research management application may also include an advanced research request search interface (not shown) that operates substantially similar to advanced knowledge base search interface 800. These knowledge base searches can be accessed using add to KB (Knowledge Base) button 2215 (as shown in FIG. 22). By accessing this action item, a user can figure out what other KBs have been created and/or used (e.g., for projects, request types, client/matters, etc.). This may help enable a user to easily access information related to previous searches. In addition, this may allow a user to re-use information found, rather than having to spend time working on the same or similar research that has already been done.

For example, if an attorney (Requester=“RQ”) sends a Request (“R”) to the Library (Responder (“RP”) team), someone is assigned or picks up the request and uses all the features of the software (“Q”) to answer the request. After the answer is sent, the R is saved in the R archive and can be searched to update, reuse, and/or build upon for a new matter, work already performed.

The RP team and/or an administrator can also create an organized Knowledge Base (“KB”) for the entire firm/enterprise/organization/public entity and/or a limited sub-group and/or be able to construct “Chinese walls” to prevent access to certain parties to be able to search information that is tagged and formatted for easy retrieval for anyone with access. In some embodiments, there does NOT have to be a request created or tied to a KB entry (although, in some embodiments, there can be).

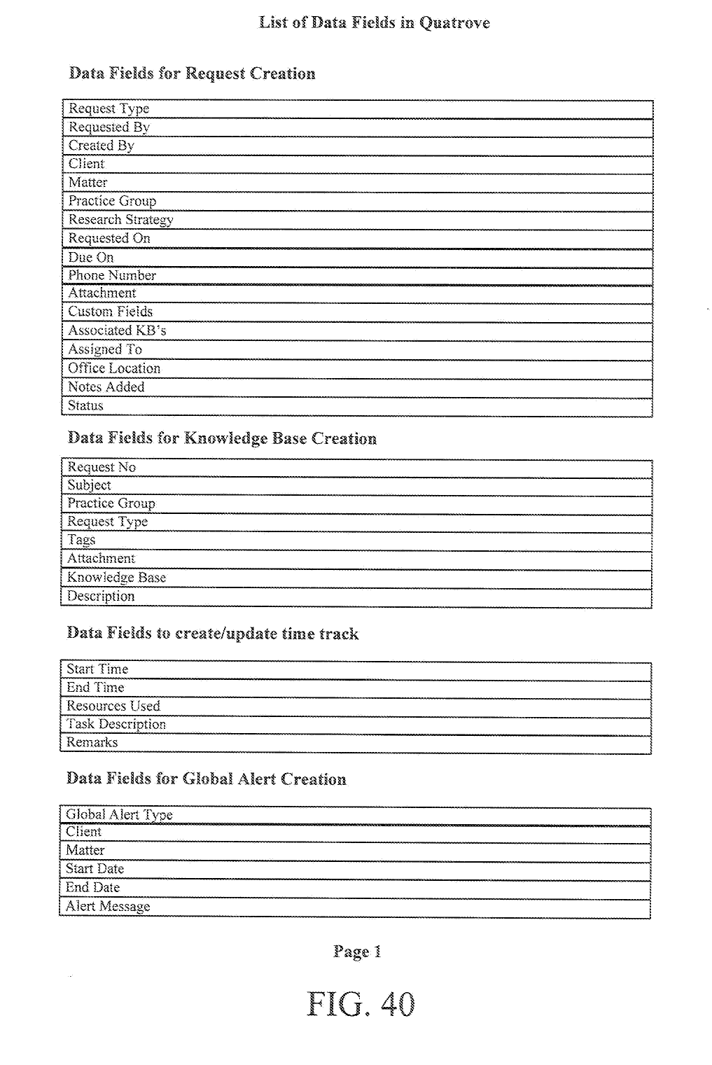

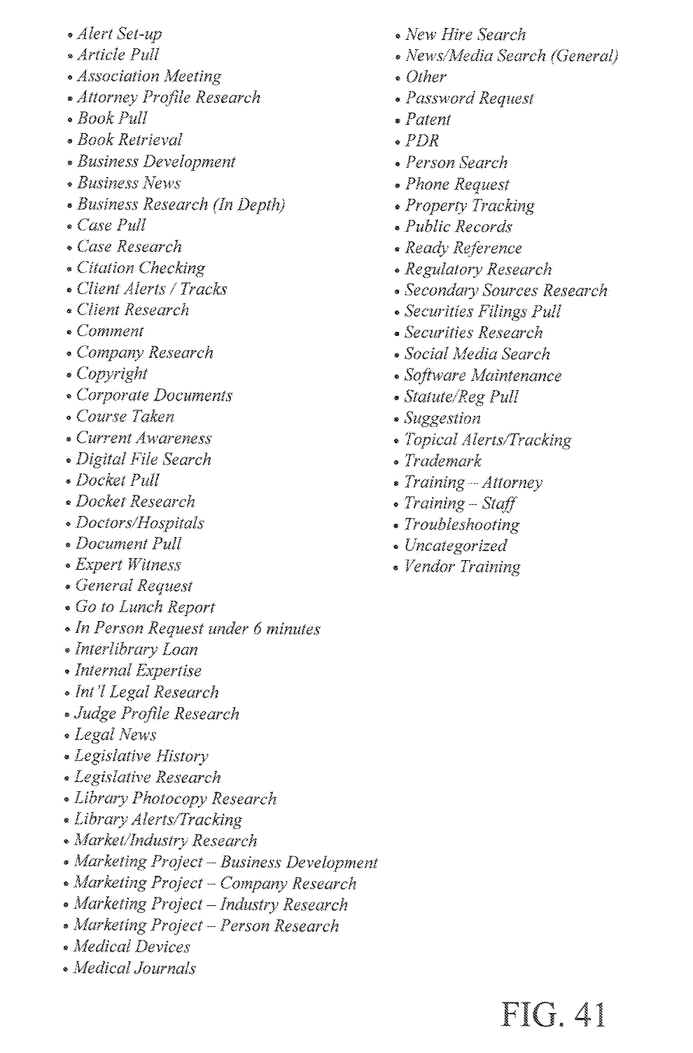

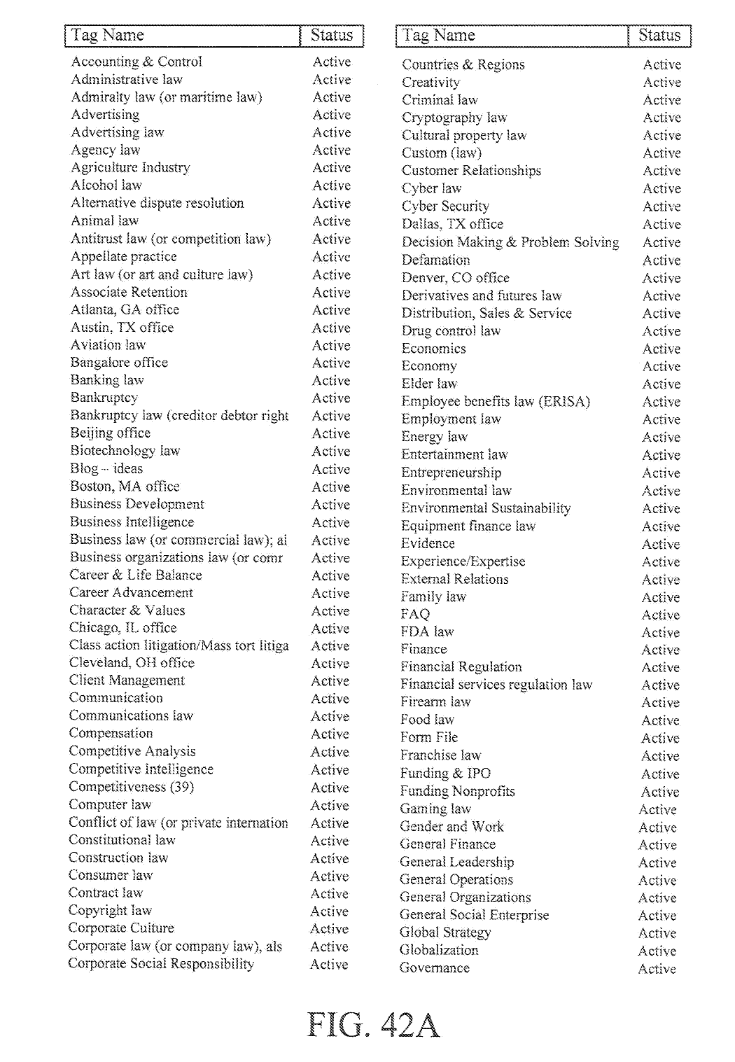

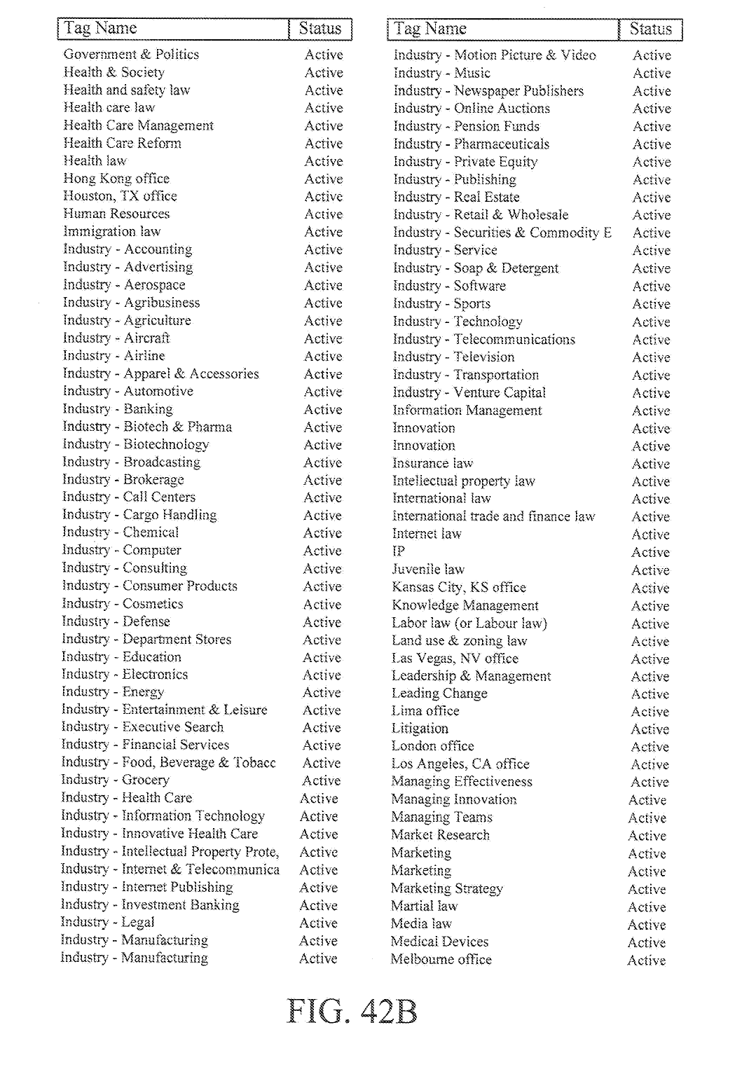

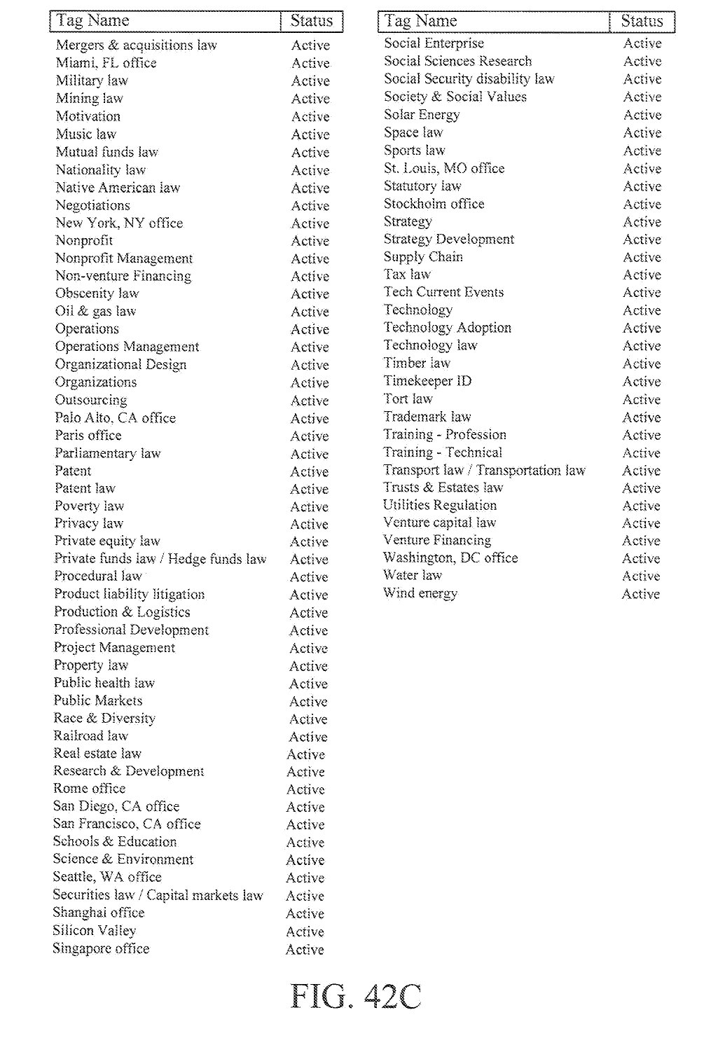

The KB and/or the Rs can be searched with a general word search, a field search (e.g. simple or advanced), or an optional intelligent search, or any combination thereof. A field search may search recommended or customized fields. FIG. 40 is a list of example recommended fields. The user can determine which of these fields to use, and customized fields may be also added by the user or administrator. One field type may be request types. FIG. 41 is a list of example recommended request types. The user can determine which of these request types to use, and customized request types may also be added by the user. Another field type may be tags, where the responder and/or requester may tag search results, a partial or complete record of the R or a KB entry with certain tags. FIGS. 42A-42C is a list of example tags. The user can determine which of these tags to use, and original customized tags may also be added by the user depending on their unique search and taxonomy needs as well as any specific nomenclature requirements. The optional intelligent search may return results that may not contain the specific terms searched, but may return potentially relevant documents that contain terms and/or combination(s) of terms that may provide additional relevant data. For example, a user may search for the terms “agriculture” and “business”. Intelligent search functionality will delivery results that include alternatives such as “agribusiness” that may be relevant but not otherwise retrieved by the specific search terms used. Intelligent search will also provide recommendations for additional narrowing of searches if a search results in a very large number records. An example is where the terms “employer” “employee” and “discrimination” are searched with a large number of results. Intelligent search will provide a menu or box containing possible relevant tags, add similar search terms or other means for the user to, at their choosing, narrow the search for more relevant results. In this example, that may be the tags or terms “gender discrimination”, “age discrimination” or others.

The searching of the KB and/or the Rs can be set up so that any entity can search and/or access any type of KB and/or R records it wishes if the appropriate permissions are in place. Thus, for example, a firm can set up searching capability of KB and/or R records so that team members can search any KB and/or R records of any team member or parameter as given permission by the administrator, and the library staff can search any KB and/or R records of any person in the firm. Special exceptions to limit access can be made for sensitive clients, matters, or firm staff (e.g., a high profile partner). In some embodiments, names of the persons requesting the research and/or client/matter numbers may be removed.

Similarly, groups of entities may decide to share KB and/or R records in order to make research more effective. In some embodiments, names of the entities, persons requesting the research and/or client/matter numbers may be removed.

Similarly, permissions may be obtained from clients so that KB and/or R records may be utilized from various clients for other clients to access research data. In some embodiments, names of the entities, persons requesting the research and/or client/matter numbers may be removed.

Examples of KB strategy include, but are not limited to, the following: 1) INTRANET REPLACEMENT/SUPPLEMENTATION: The KB feature is able to replace a firm/enterprise/organization/public entity intranet, thus saving the cost and staff time for implementation and maintenance. 2) EXPERIENCE/EXPERTISE DATABASE: A firm/enterprise/organization/public entity are spending a lot of money on implementing experience/expertise databases. The KB feature could replace those additional costs, even efforts with an effective tagging system. (e.g., when a Request is completed, the RP or RQ forwards the R to the KB with the expertise/experience (“EX”) tag. Then, the KB may contain data about EX that is based on real work as opposed to self-reported information that is usually not found.) 3) TRAINING/PROFESSIONAL DEVELOPMENT: A firm/enterprise/organization/public entity may spend too many wasted work hours on finding and disseminating training and professional development materials. The KB can provide a well-organized, easily accessible/searchable source for such materials. 4) INDIVIDUALS OR SMALL ENTITIES: An off-the-shelf KB solution may help individuals and/or small entities to be able to capture, save, search for and/or reuse work already performed in a safe and secure environment.

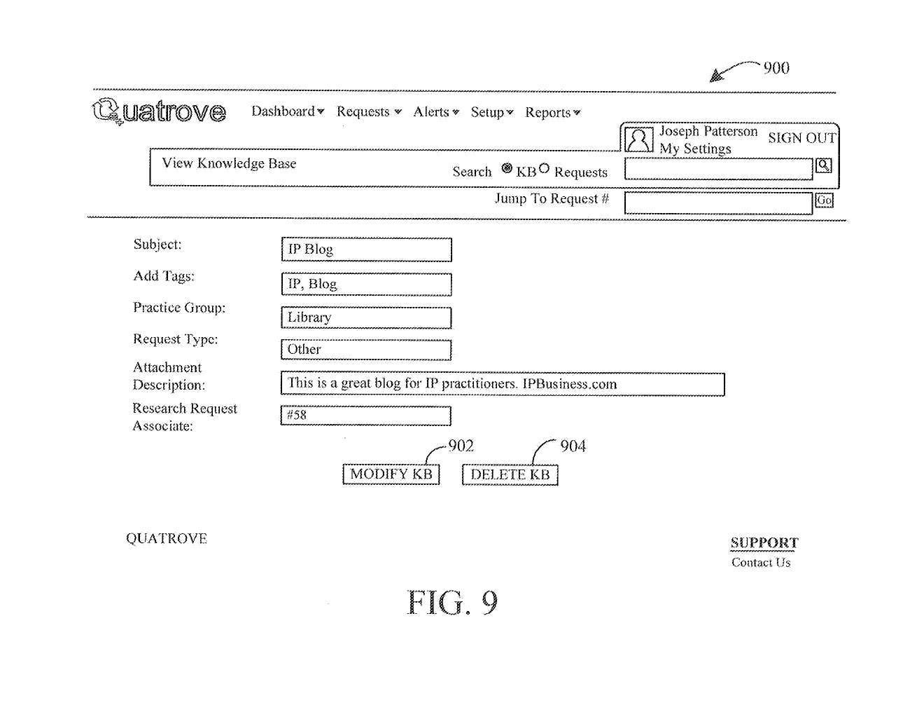

When user 112 selects a particular knowledge base, for example from search results interface 700, a view knowledge base interface 900 may be displayed, as shown in FIG. 9. View knowledge base interface 900 may display the subject, tags, practice group, request type, and description of the selected knowledge base. The numbers of any research requests 310 associated with the knowledge base may also displayed. View knowledge base interface 900 may include a modify knowledge base button 902 that may enable user 112 to modify the selected knowledge base, as well as a delete knowledge base button 904 that may enable user 112 to delete the selected knowledge base from the research request management application.

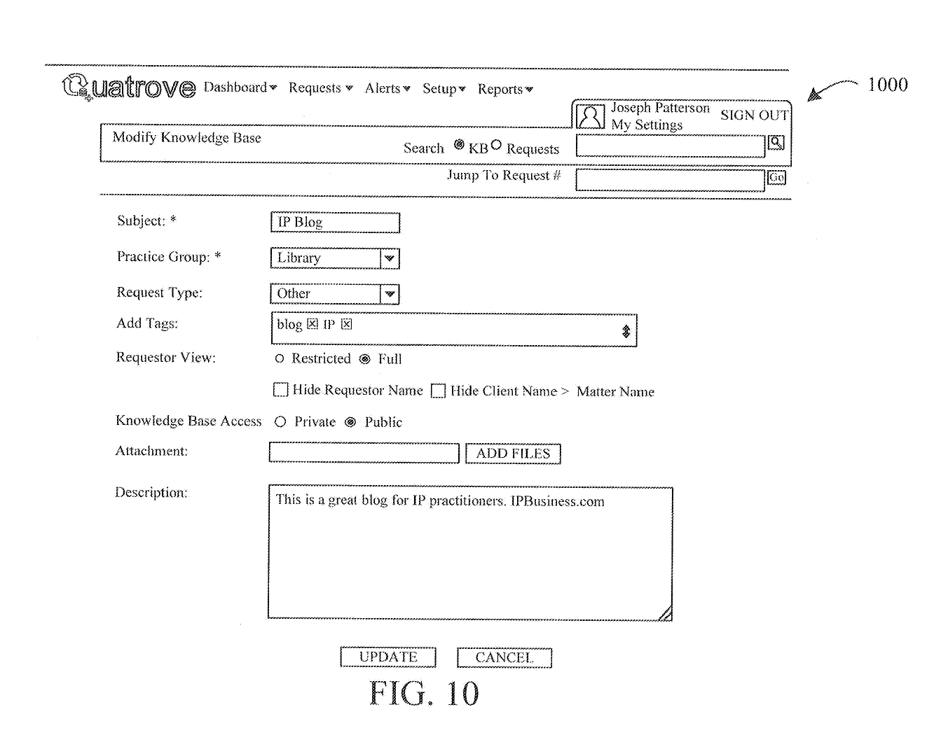

Research request server 202 may generate a modify knowledge base interface 1000, as shown in FIG. 10, when user 112 selects modify knowledge base button 902. Modify knowledge base interface 1000 may enable changing one or more characteristics of an existing knowledge base. In the example embodiment, modify knowledge base interface 1000 may enable user 112 to change the subject, practice group, request type, access level, and/or description of the selected knowledge base. Tags and attachments can also be added or removed from the knowledge base. Modify knowledge base interface 1000 may also allow user 112 to specify a requestor view option for the knowledge base. When the requestor view is set to restricted, requestors may not view the knowledge base. When the requestor view is set to full, requestors may view the knowledge base. The requestor name and client/matter name may also be selectively hidden, using modify knowledge base interface 1000.

Referring back to FIG. 3, dashboard interface 300 may include a plurality of high-level drop down menus 350 (e.g., Dashboard, Requests, Alerts, Setup, Reports). In the example embodiment, each drop-down menu 350 may include a plurality of links that enable user 112 to access other interfaces of the research request management application.

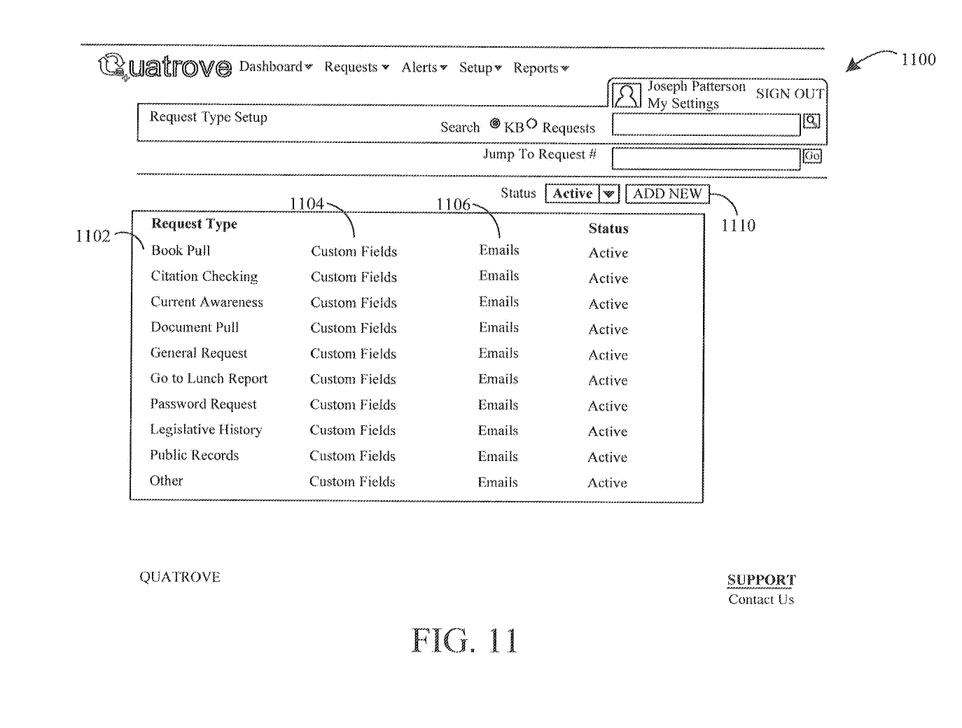

When a request type link is selected from the setup drop-down menu 350, a request type setup interface 1100 may be generated by research request server 202, as shown in FIG. 11. Request type setup interface 1100 may enable an administrator to create request types 102 for research requests 310 in the research request management application. In the example embodiment, each research request 310 may be associated with one request type 1102. Alternatively, research requests 310 may not be associated with a request type 1102. By selecting a custom fields link 1104 or an emails link 1106, the user 112 can modify/configure the setting for an associated request type 1102.

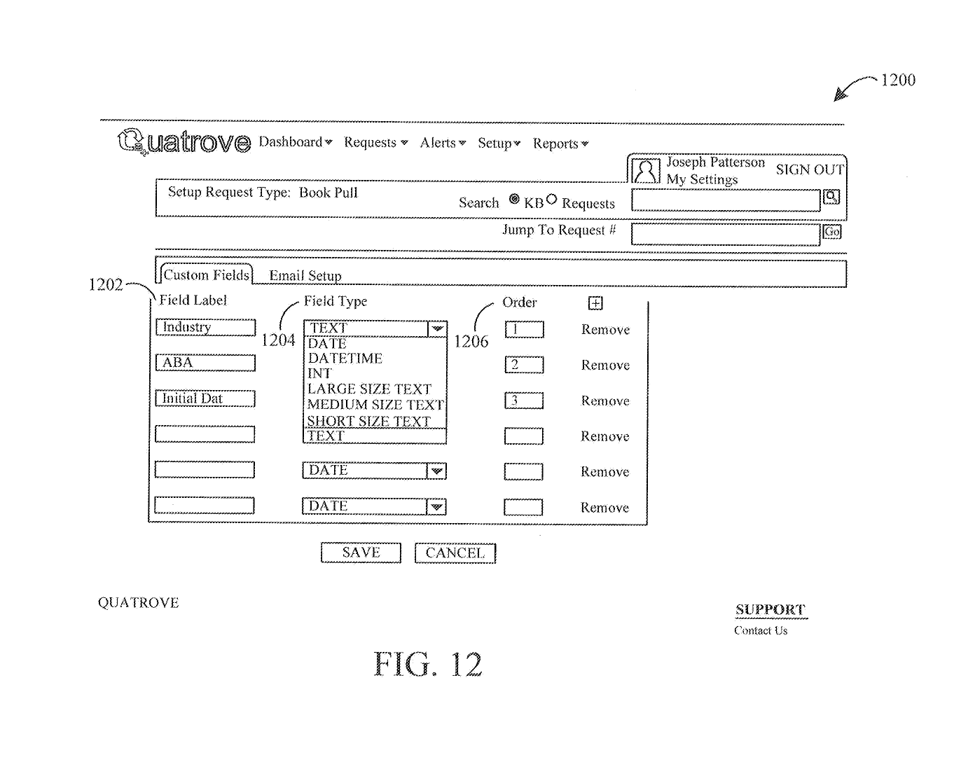

FIG. 12 is an example custom fields configuration interface 1200 that may be displayed when the user 112 selects custom fields link 1104. Custom fields configuration interface 1200 may enable the user 112 to create one or more fields that will be associated with a particular request type 1102. As shown in FIG. 12, the user 112 can specify a field label 1202, a field type 1204 (e.g., date, text, etc.), and an order 1206. The order 1206 may specify in what order the created fields will appear in the request type 1102. For example, from the information entered in custom fields configuration interface 1200 as shown in FIG. 12, an “Industry” field may appear first, followed by an “Initial Dat” field, followed by an “ABA” field.

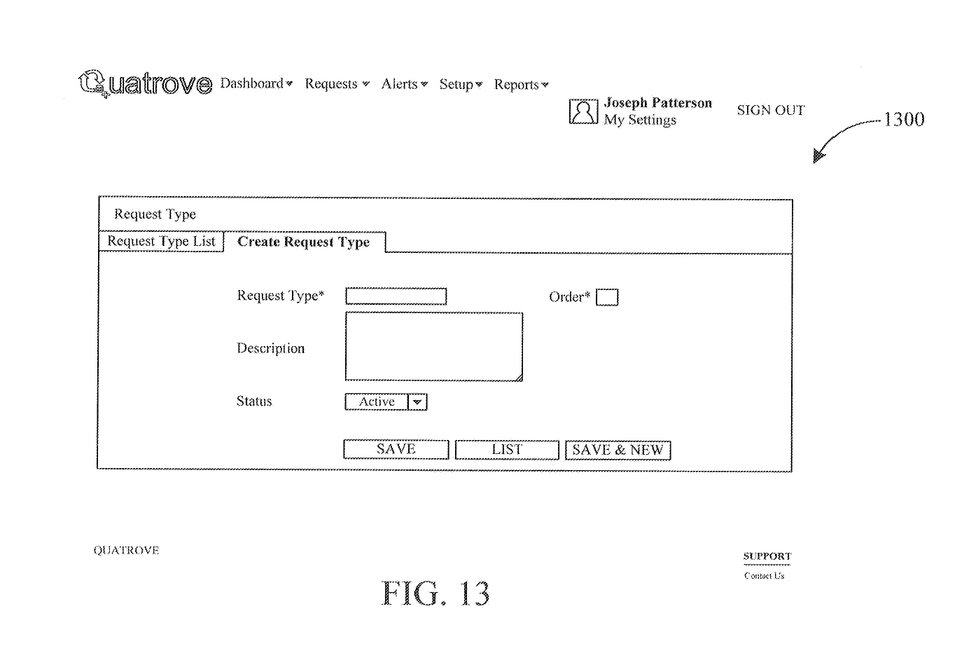

Referring back to FIG. 11, by selecting an add new request type button 1110, the user 112 can create a new request type using create request type interface 1300, as shown in FIG. 13. Create request type interface 1300 may enable the user 112 to specify a title for the request type, a description of the request type, and an order for the request type (e.g., where the created request type will appear on a list of selectable request types). The user 112 may also specify whether the created request type is active (e.g., appears in a list of selectable request types) or inactive (e.g., does not appear in a list of selectable request types).

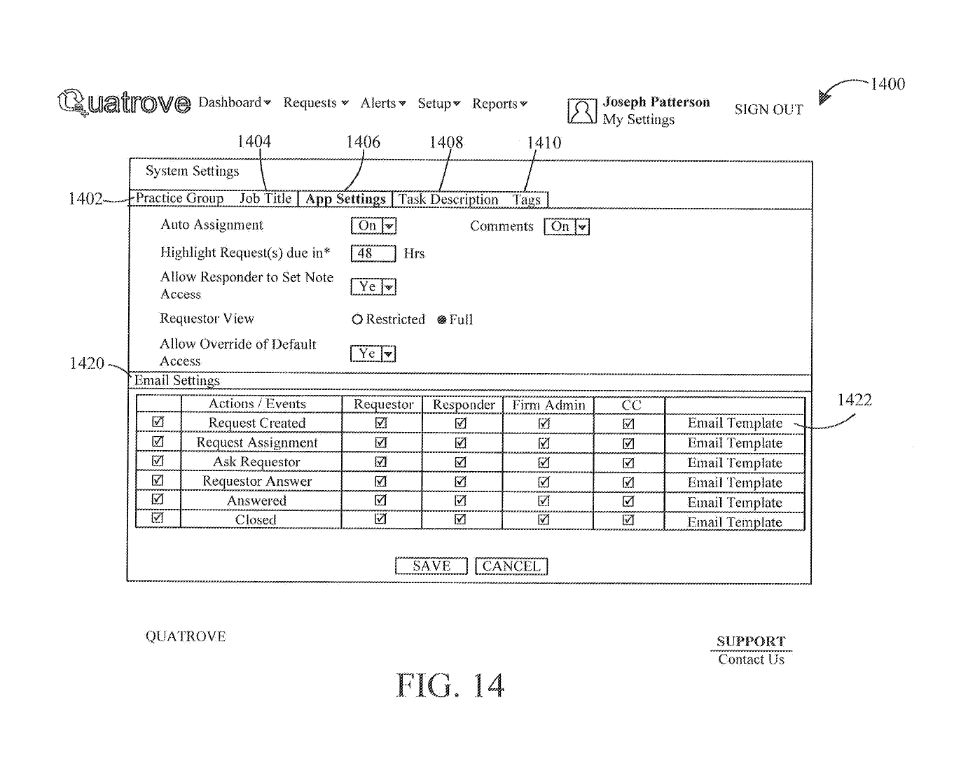

Referring back to FIG. 3, by selecting a system settings link from setup drop-down menu 350, research request server 202 may generate a system settings interface 1400, as shown in FIGS. 14, 16, and 17. Systems settings interface 1400 may include a practice group tab 1402, a job title tab 1404, an app settings tab 1406, a task description tab 1408 and a tags tab 1410. Selecting practice group tab 1402 may permit administrator user 112 to create and/or edit practice groups within the organization (e.g., the law firm). Selecting job title tab 1404 may permit administrator user 112 to create and/or edit classifications (e.g., administrator, requestor, or responder) of users 112 of the research request management application.

In FIG. 14, app settings tab 1406 has been selected by the user 112. With app settings tab 1406 selected, an administrator can select whether research requests 310 are auto-assigned to responders, select whether generating comments on research requests 310 is permitted, specify what requests 310 should be highlighted, select whether responders are permitted to set note access on research requests 310, set a requestor view to full or restricted, and specify whether default access to research requests 310 can be overridden. Setting a requester view as full or restricted may be helpful because a searches under a certain requestor's name can be restricted from other users. Thus, for example, if a request requires high security and discretion, the requestor's name along with the client and matter information and the actual search information can be blocked out and/or hidden from other users of the system. Permission to see the requestor's name, client/matter information, and/or the search information may be given to certain users.

Email settings related to research requests 310 can also be modified/configured from the app settings tab 1406 in an email settings panel 1420. In the example embodiment, the research request management application may be linked to email accounts of one or more administrators, requestors, responders, and/or cc'd personnel. Accordingly, when certain actions are taken in the research request management application, an email notification is automatically generated and sent to appropriate parties. As shown in FIG. 14, events triggering email notifications may include creating a research request 310, assigning a research request 310, asking a question of a requestor, answering a question posed to a requestor, answering (e.g., completing) a research request 310, and/or closing a research request. Email notifications may be sent to the requestor, responder, firm administrator, and/or cc'd personnel associated with the particular research request 310, and one or more users may be cc'd on the email notification.

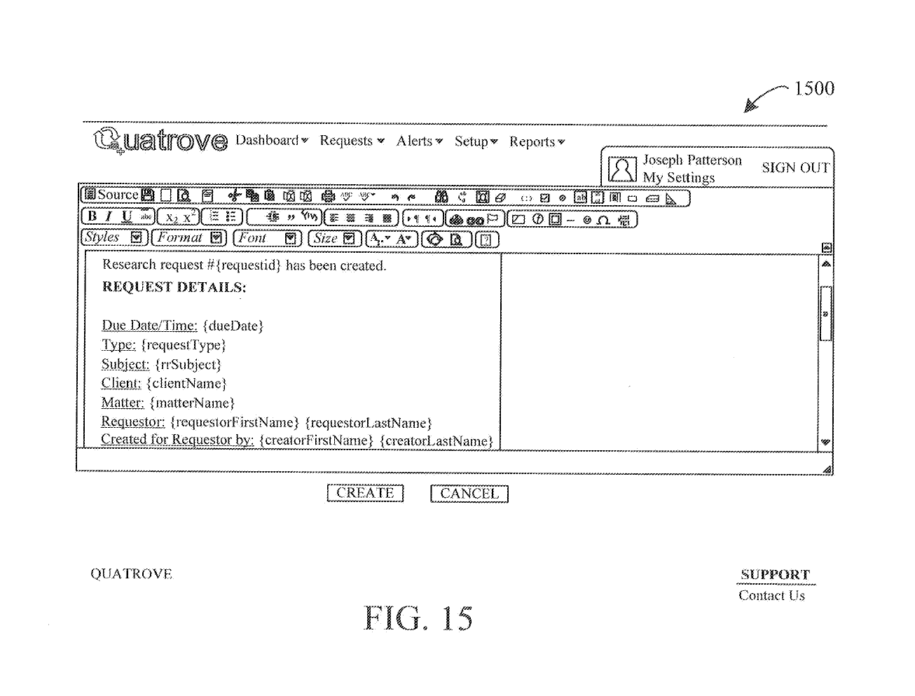

An administrator user 112 can modify and/or configure a template email notification by selecting an email template link 1422 on email settings panel 1420. In response, research request server 202 may generate an email template modification interface 1500, as shown in FIG. 15. Using the email template modification interface 1500, the administrator user 112 can manipulate an email template (e.g. add/remove hyperlinks, tags, images, text, etc.) such that notification emails transmitted by research request server 202 may appear in a format desired by the administrator user 112.

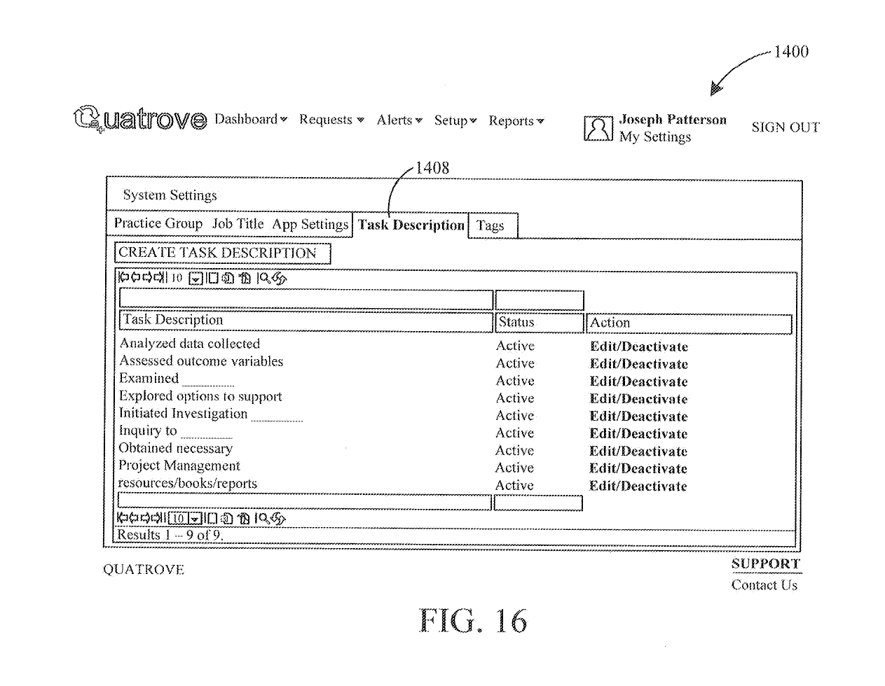

In FIG. 16, task description tab 1408 has been selected on system settings interface 1400. Task descriptions, as used herein, may refer to identifiers that responders use when justifying their time working on research requests. That is, responders may use task descriptors when logging their time spent working on research requests. Using system settings interface 1400, an administrator user 112 can add new task descriptions, remove existing task descriptions, edit existing task descriptions, or select whether existing task descriptions are active (e.g., usable by responders) or inactive (e.g., not usable by responders). Moreover, an administrator user 112 is able to create a task description abbreviation, such that a user is able to type in only the abbreviation, and the selected sentence and/or phrase associated with the abbreviation may then be presented for the user to choose to incorporate into a task description. A task description abbreviation may make it easier for a user to enter in time for a task. It may also make time entries for similar tasks consistent such that invoices and records are consistent. This may enable analytics run using the time entries to be more accurate and more easily usable (e.g., for alternative fee arrangements, staffing decisions, etc.).

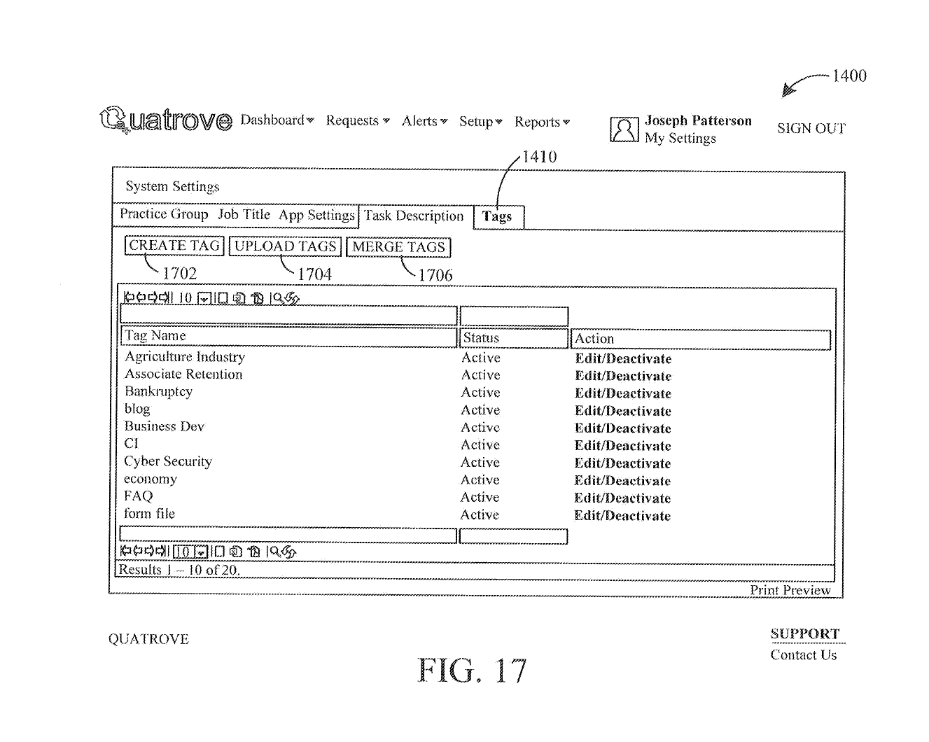

In FIG. 17, tags tab 1410 has been selected on system settings interface 1400. Tags tab 1410 may enables user 112 to modify and/or configure one or more tags to be added to knowledge bases in the research request management application. New tags can be created using a create tag button 1702, tags can be uploaded to research request management application using an upload tag button 1704, and tags may be merged using a merge tab button 1706. Further, using tags tab 1410, tags may be edited, activated, and/or deactivated by user 112.

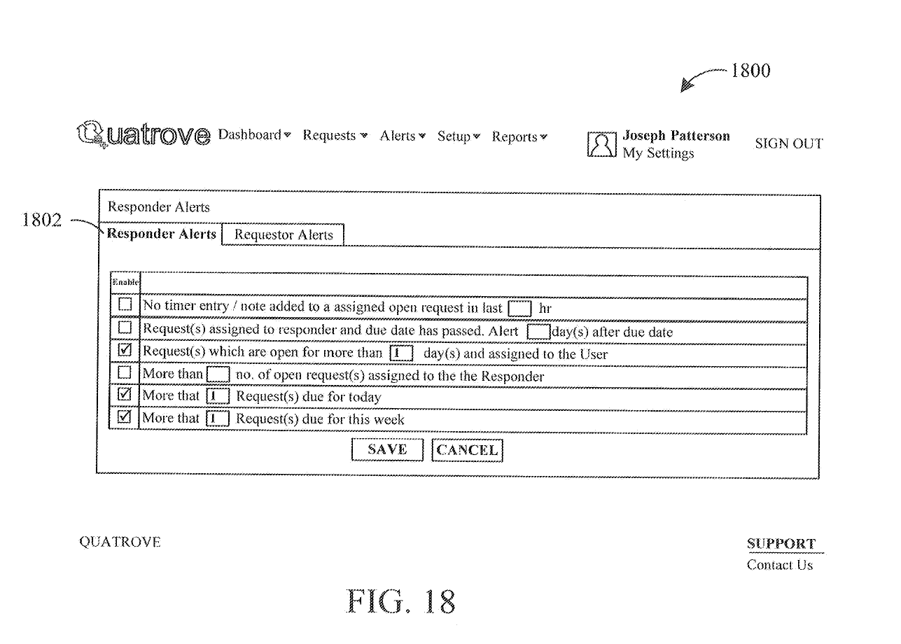

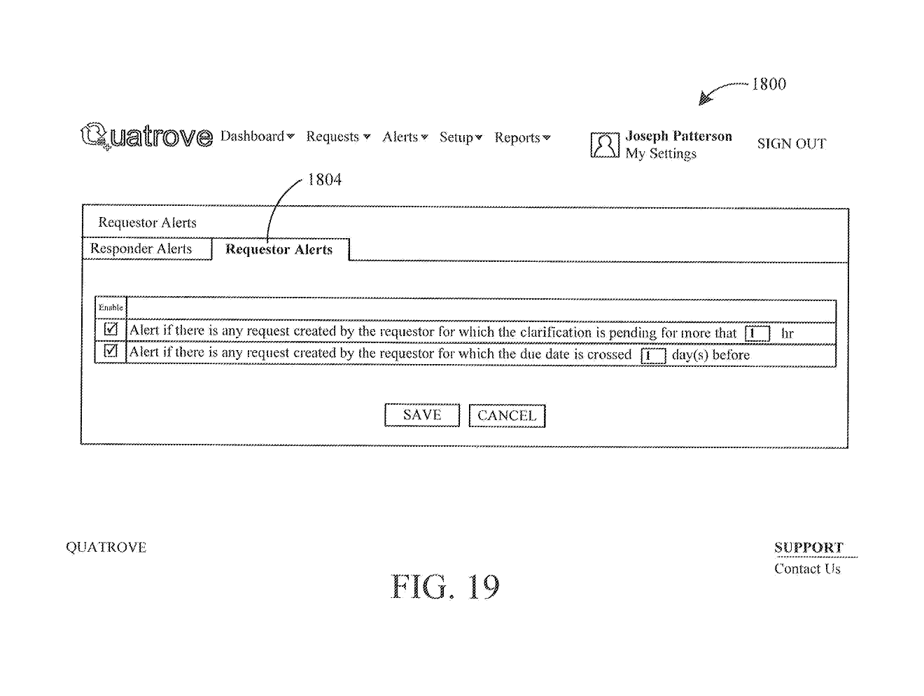

FIGS. 18 and 19 illustrate example user alerts interface 1800 generated by research request server 202. User alerts interface 1800 may include a responder alerts tab 1802 and a requestor alerts tab 1804. As shown in FIG. 18, with responder alerts tab 1802 selected, an administrator user 112 can select when a responder receives alerts regarding a research request, for example, via email. Alerts may also appear in a responder dashboard interface, as described below. In the example embodiment, the research request management application may send an alert to a responder when no time entry and/or note has been added to the request within a particular time, when a due date of a request has passed, when requests are open and assigned for a selected number of days, when more than a selected number of requests are assigned to the responder, when more than a selected number of requests are due for today, and/or when more than a selected number of requests are due for the week.

In FIG. 19, requestor alerts tab 1804 is selected. Using requestor alerts tab 1804, an administrator user 112 can select when a requestor receives alerts regarding a research request, for example, via email. Alerts may also appear in a requestor dashboard interface, as described below. In the example embodiment, the research request management application may send an alert to the requestor when a request is created by the requestor for which clarification is pending for more than a selected amount of time, and/or when a request created by the requestor has passed the due date a selected amount of days ago.

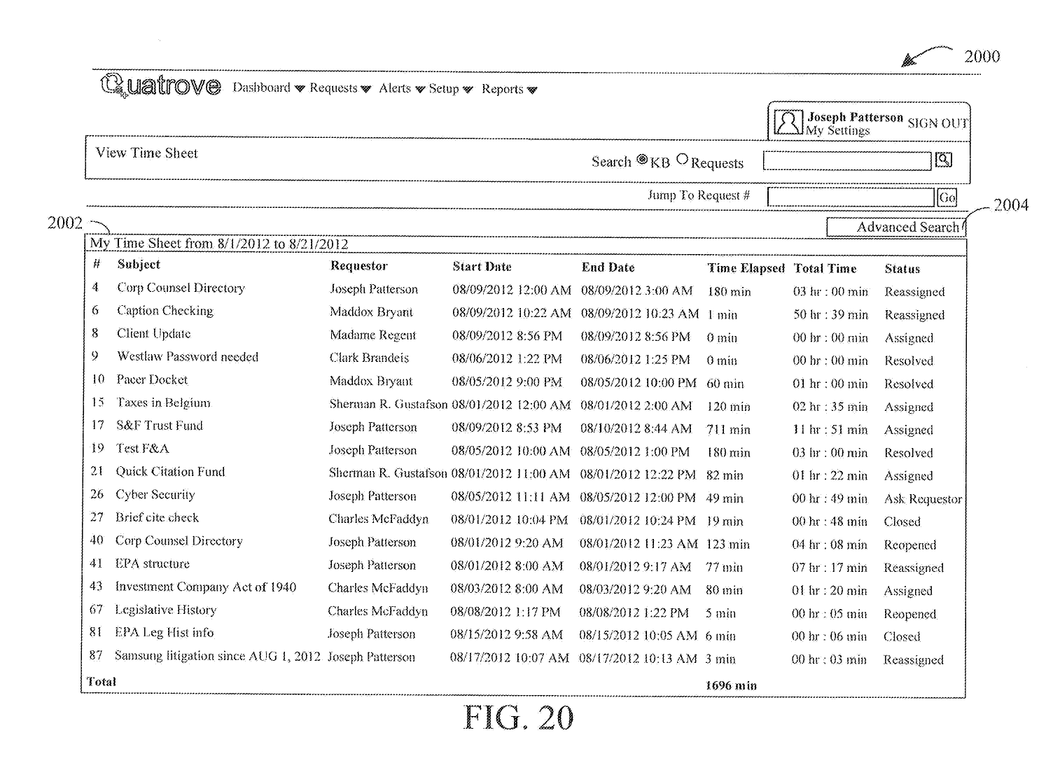

FIG. 20 illustrates an example time sheet interface 2000 generated using research request server 202. Time sheet interface 2000 may include a time sheet report 2002 that displays all the requests 310 that the user 112 has worked on. By selecting an advanced search link 2004, the user 112 can filter time sheet report 2002 to only display requests within a specified time period. In the example embodiment, each research request 310 displayed on time sheet report 2002 may include the number, subject, requestor, start date, end date, time elapsed, total time, and status of each research request 310. Alternatively, depending on the law firm's needs, any suitable information may be displayed for research requests 310 in time sheet report 2002. By selecting an export button (not shown in FIG. 20), user 112 can export the time sheet report 2002 as a .pdf file, an .xls file, a .csv file, and/or in any other suitable format. In at least some embodiments, the particular fields displayed and/or the order of the fields displayed in the exported report can be customized and/or specified by user 112.

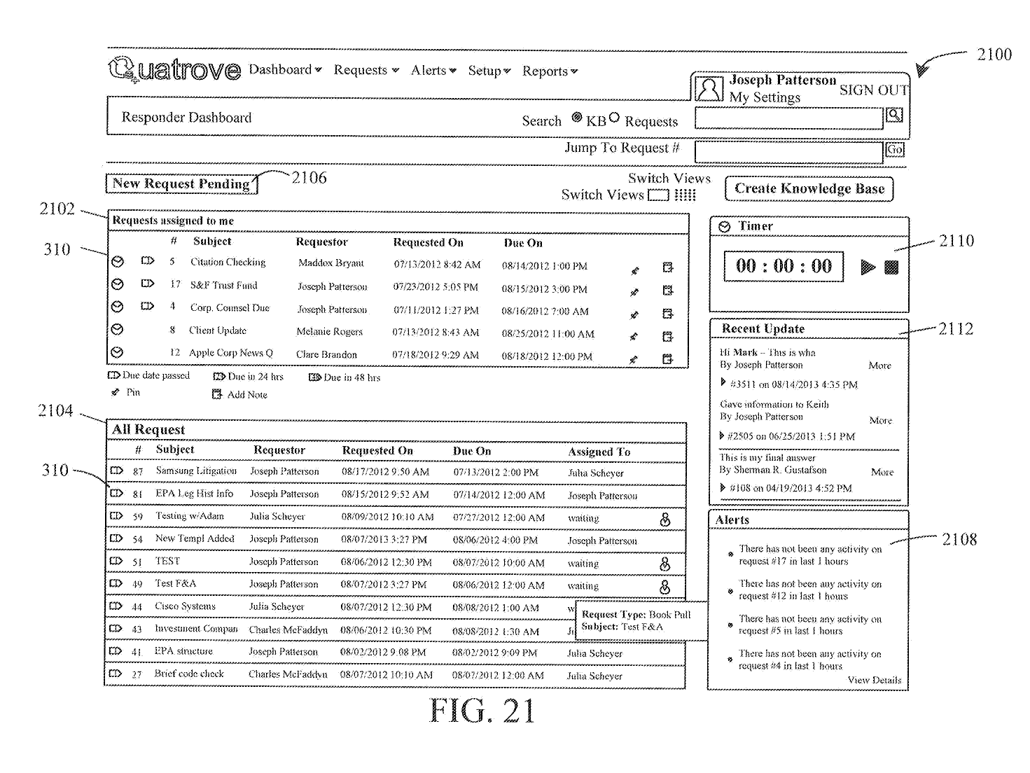

FIG. 21 illustrates an example responder dashboard interface 2100 generated by research request server 202 for a responder user 112. Similar to dashboard interface 300, responder dashboard interface 2100 may display research requests 310. In responder dashboard interface 2100, research requests 310 may be listed in a responder requests section 2102 and/or an all requests section 2014. Responder requests section 2102 may list research requests 310 assigned to the user 112 viewing responder dashboard interface 2100, and all requests section 2104 may list all research requests 310 visible to user 112. When a new request 310 is generated for the user 112, a new request pending alert 2106 may be displayed on responder dashboard interface 2100. Responder dashboard interface 2100, in the example embodiment, may include a timer section 2110 that may enable the responder user 112 to track the amount of time spent on a particular research request. Moreover, a recent updates section 2112 may also be presented on the responder dashboard interface 2100, where any communication from a requestor (e.g., email or other communication) may be indicated. The recent updates section 2112 may thus enable a responder to see a requestor's question and/or answer and/or reply without checking his or her email inbox Responder dashboard interface 2100 may also include an alerts section 2108 that include alerts generated according to, for example, responder alerts tab 1802 (shown in FIG. 18).

When a responder user 112 selects a particular research request 310, a view request interface 2200 may be displayed, as shown in FIGS. 22-24. View request interface 2200 may include information about the selected research request 310 organized in a data tab 2202, a history tab 2204, and a description tab 2206. As shown in FIG. 22, data tab 2202 may include details such as the client, matter, requestor, responder, practice group, timer, and dates associated with the selected research request 310. Using an actions panel 2210, the user 112 may also take one or more actions related to the research request 310, including, but not limited to, adding a note, activating time track (described below), adding the research request 310 to a knowledge base, asking requestor a question, answering the research request 310, editing the research request 310, and deleting the research request 310. In addition, as shown by 2220, the user 112 may also draft correspondence (status update, question, answer, note, etc.) and send it to the requestor. In this way, the user does not need to access his or her email application, but instead can remain in the workspace so that all work associated with the research may be handled by the research request system 200. Note that, in some embodiments, when a research request is created, all persons associated with that research request may be listed so that these persons all receive all correspondence related to the research request. The correspondence may be created using HTML editing functionality so that the correspondence appears to be part of the regular workflow of the system.

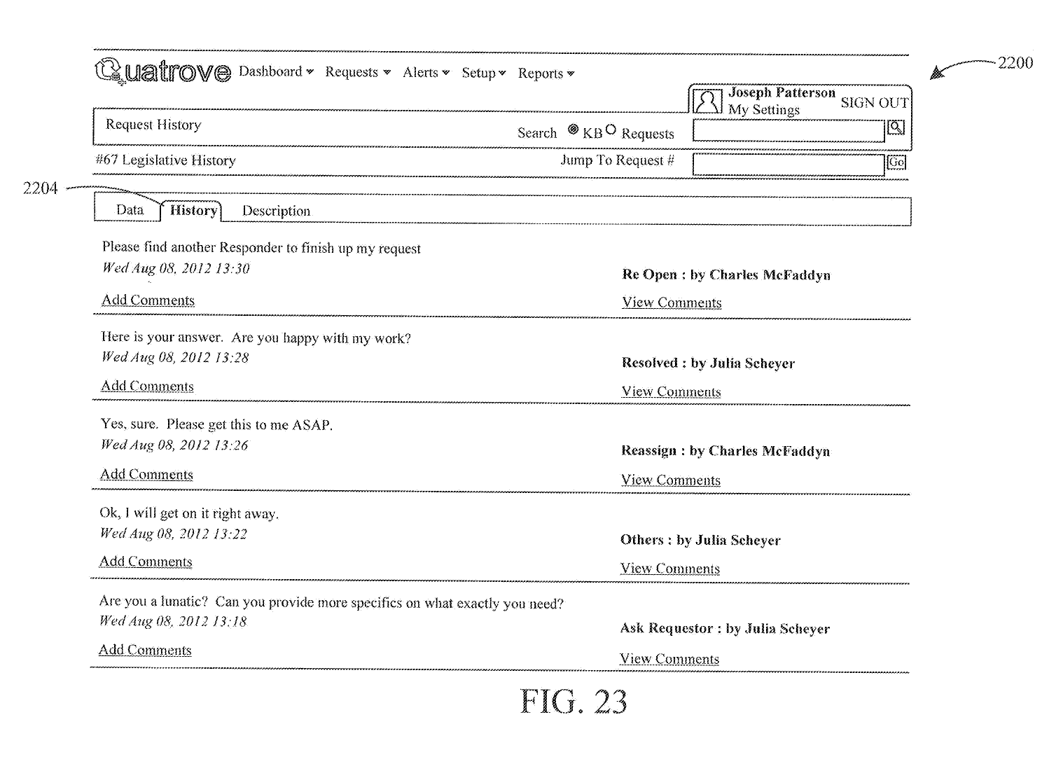

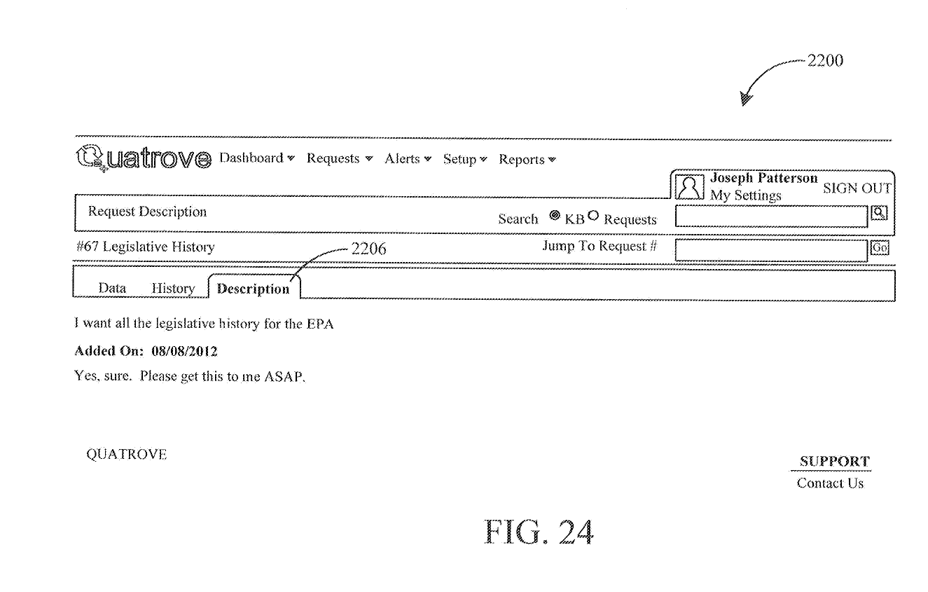

History tab 2204, as shown in FIG. 23, may include all recorded communications and/or email exchanges regarding the selected research request 310. That is, when users 112 (e.g., administrators, requestors, responders) send e-mail to each other regarding the selected research request 310, that correspondence may be stored and tracked by research request server 202. Accordingly, by viewing history tab 2204, a particular user 112 can quickly review all communications logged regarding the selected research request 310. Description tab 2206 may include the description of the selected research request 310, as shown in FIG. 24.

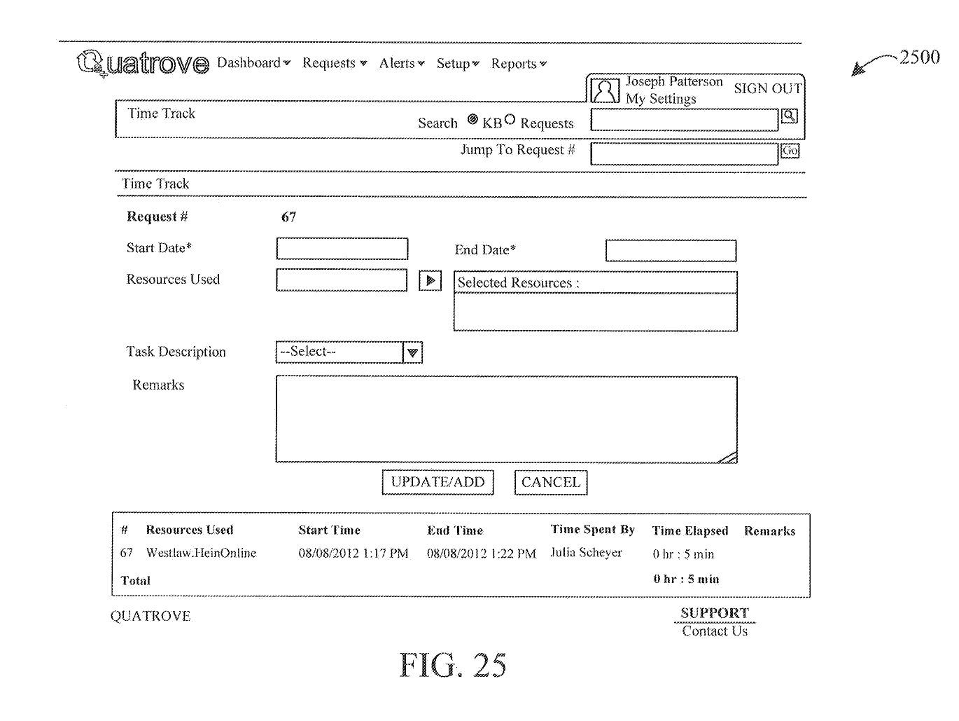

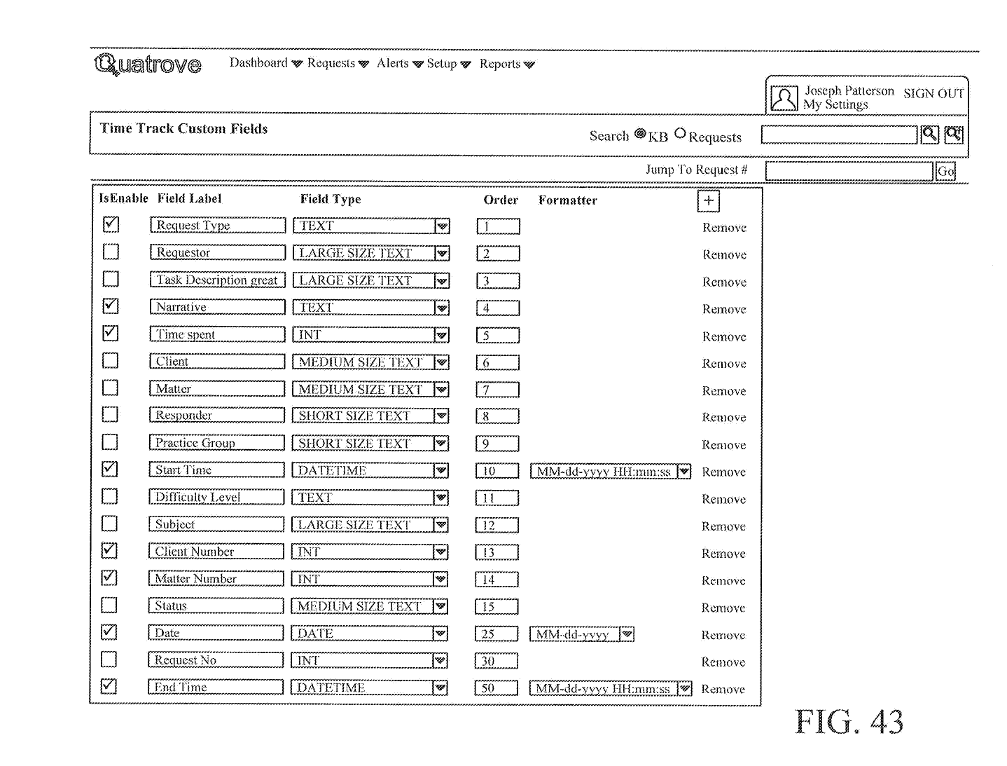

FIG. 25 illustrates an example time track interface 2500 generated using research request server 202. Time track interface 2500 may be accessible, in the example embodiment, by selecting a time track action on actions panel 2210 (shown in FIG. 22). Time track interface 2500 may enable the responder user 112 to enter information related to responder's work on the selected research request 310. In the example embodiment, responder user 112 can enter a start date, end date, research resources used, task description, and remarks. (FIG. 43 illustrates an example list of time track custom fields). For research resources used, the responder user 112 may enters online and/or offline sources utilized while working on the selected research request 310. This may enable requestors to monitor the resources being used to ensure research requests 310 are being completed thoroughly and efficiently.

From information entered in time track interface 2500, administrative personnel may be able to determine enterprise research habits to analyze research workflow and uncover potential improvements in efficiency and cost reduction. For example, the time track data may show a particular resource being used for one type of project, when a better and/or more cost effective alternative resource is available. Thus, the time track data may enable administrative personnel to direct use of such alternative resources, improving the quality and reducing the cost of specific research projects. Further, for procurement purposes, library staff may monitor which research resources are used or are not used. For example, if a library staff member determines from time track data that a particular resource is never used for any research requests 310, the library staff member may elect to not renew a subscription to that particular resource.

Available task descriptions may be generated using task description tab 1408 (shown in FIG. 16), and responder users 112 can enter available task descriptions in time track interface 2500. Task descriptions may enable requestors and/or administrators to quickly and easily ascertain the nature of the work undertaken on research requests 310, which may be valuable information when determining whether or not to bill a client for the work.

By reviewing information entered into time track interface 2500 by a responder user 112, requestors and/or administrators can manage and supervise completion of research requests 310 to ensure responder is completing research requests 310 efficiently. Further, information entered into time track interface 2500 may facilitate streamlining future research requests and quality assurance of research requests. In addition, information entered into time track interface 2500 can be incorporated into a billing system and/or another time tracking system. FIG. 43 illustrates a list of possible fields that an administrator user 112 can utilize in order to export the time tracked to a billing system and/or another time tracking system. The fields may also be used for searching and/or analysis purposes. In some embodiments, to track additional information, an administrator user 112 can add additional fields (e.g., customized fields; internal and/or external task and/or work codes such as those of a particular law firm, the American Bar Association (ABA), the Association of Corporate Council (ACC) or any other legal or non-legal entity) to time track interface 2500. These additional fields may be generated, for example, using an interface similar to custom fields interface 1200 (shown in FIG. 12).

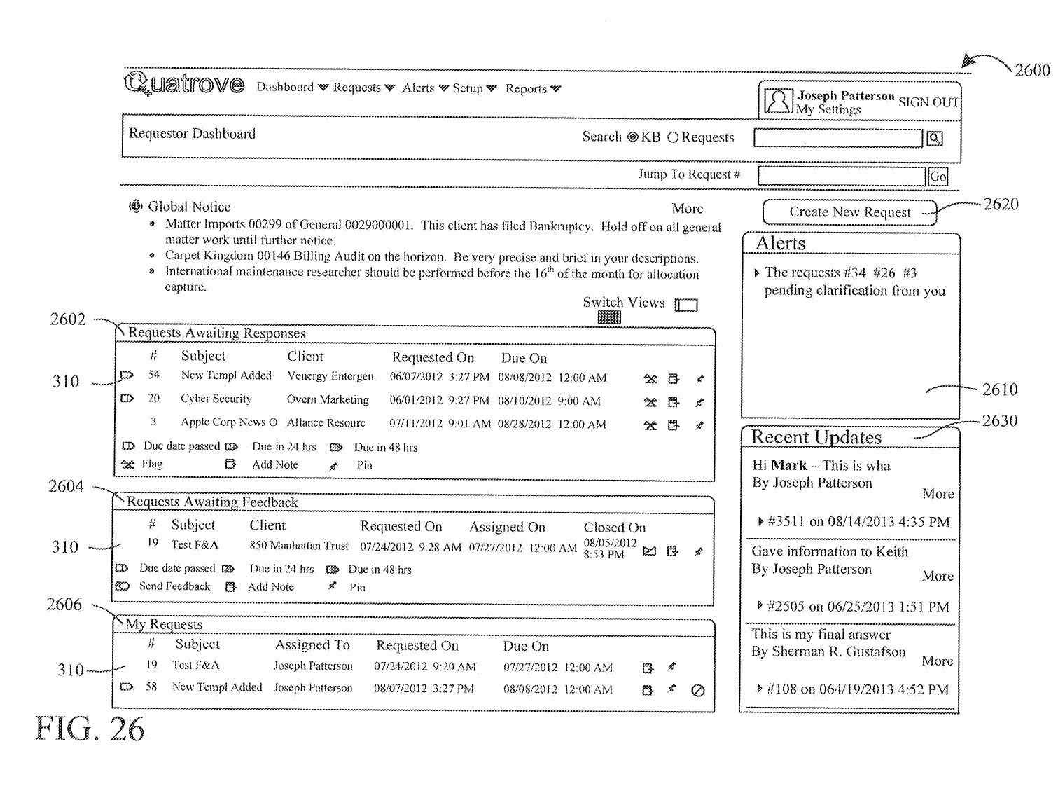

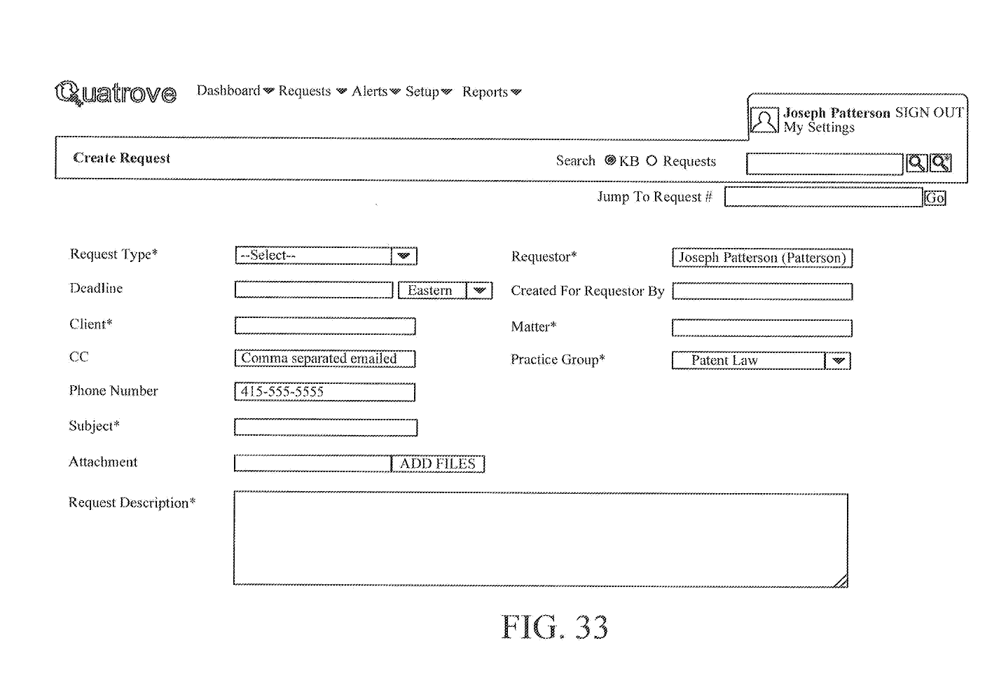

FIG. 26 illustrates an example requestor dashboard interface 2600 generated by research request server 202 for a requestor user 112. Similar to dashboard interface 300 and responder dashboard interface 2100, requestor dashboard interface 2600 displays research requests 310. In requestor dashboard interface 2600, research requests 310 may be listed in an awaiting responses section 2602, an awaiting feedback section 2604, and a requestor requests section 2606. Awaiting responses section 2602 may include research requests 310 that are awaiting responses from the requestor. Specifically, to facilitate completing research requests 310, in the example embodiment, a responder can ask the requestor one or more questions for clarification on the research request 310. These questions may be sent from the responder to the requestor via email and tracked using the research request management application, or may be sent internally within the research request management application. In addition, a create new request section 2620 may serve as a link to a create request page (shown and described in FIG. 33).

Awaiting feedback section 2604 may include research requests 310 awaiting feedback from the requestor. Specifically, after a responder has completed a research request 310, the requestor can provide feedback to the responder regarding the completed research request 310. Requestor requests section 2606 may include all research requests 310 generated by the requestor. Similar to responder dashboard interface 2100, requestor dashboard interface 2600 may include an alerts section 2610 that include alerts generated according to, for example, requestor alerts tab 1804 (shown in FIG. 19). In addition, similar to responder dashboard 2100, requestor dashboard interface 2600 may include a recent updates section 2630, where all communications from responders may be presented.

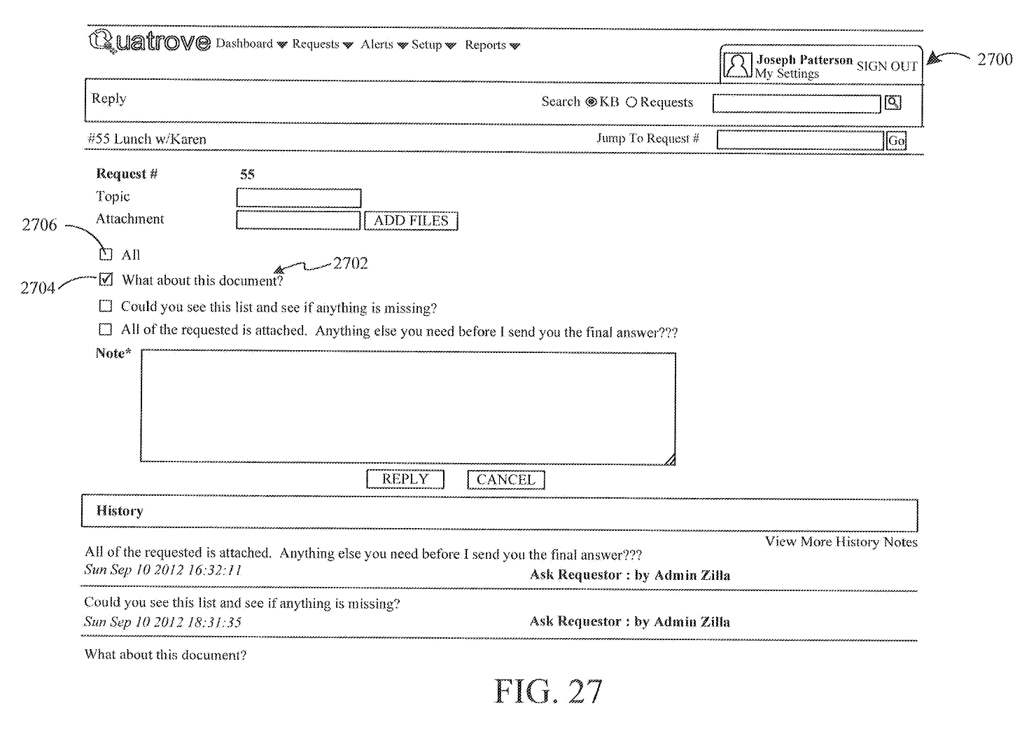

For replying to research requests 310 that are awaiting a response, research request server 202 may generate reply interface 2700, as shown in FIG. 27. Reply interface 2700 may enable the requestor to reply to a responder's question(s). As part of the response(s), the requestor can add an attachment, and select which question(s) to reply to in addition to providing a note answering the question(s). In the example embodiment, each question 2702 posed to the requestor may be displayed on reply interface 2700 with an associated check box 2704. By selecting a check box 2704, the requestor may indicate which question 2702 is being replied to. The requestor can also reply to all posed questions 2702 by selecting an all question check box 2706.

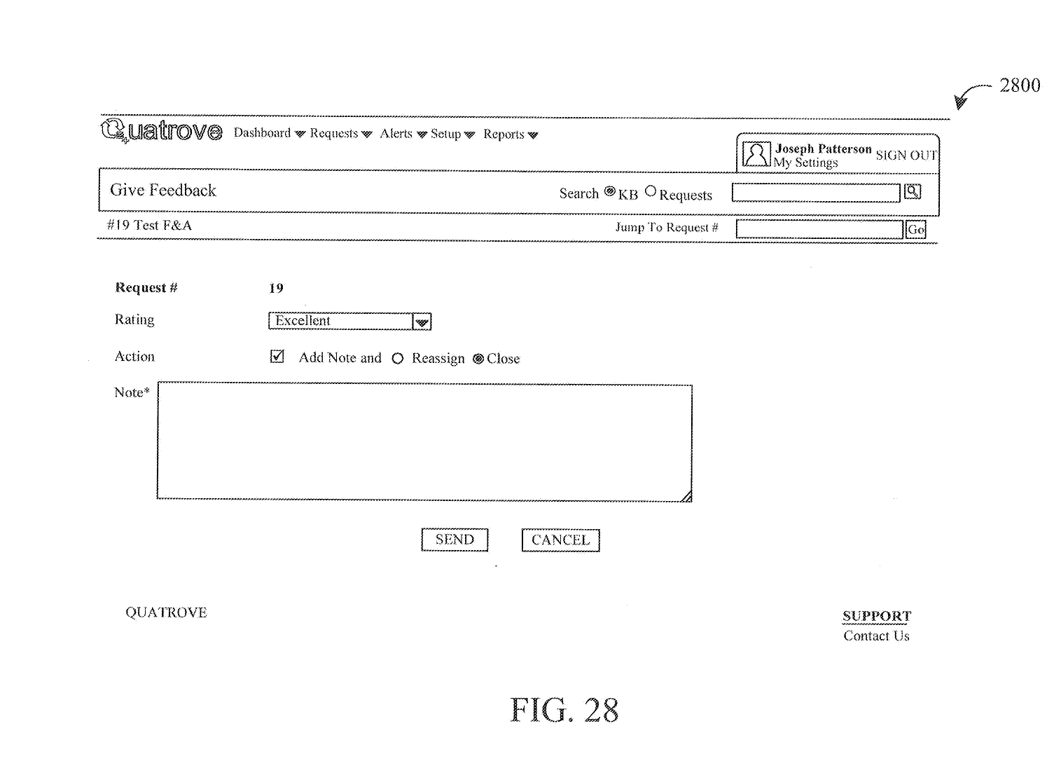

Using a feedback interface 2800, as shown in FIG. 28, the requestor can provide feedback on the responder's completion of a selected research request 310. In the example embodiment, the responder can specify one of a plurality of preset ratings, in addition to providing feedback as a note. Further, the requestor can choose to reassign the research request 310 to another responder it, for example, the requestor is unsatisfied with the work done by the assigned responder. On the other hand, if the research request 310 is complete, the requestor can choose to close the research request 310.

In some embodiments, research requests 310 may be generated in response to an email (also referred to as a “generating email”) sent to a designated email address (e.g., library@lawfirm.com). Accordingly, by emailing a request to the designated email address, users can create research requests 310 without logging into the research request management application. Further, emails generating research requests 310 may be sent from any email platform (e.g., desktop computer, laptop computer, smartphone, etc.).

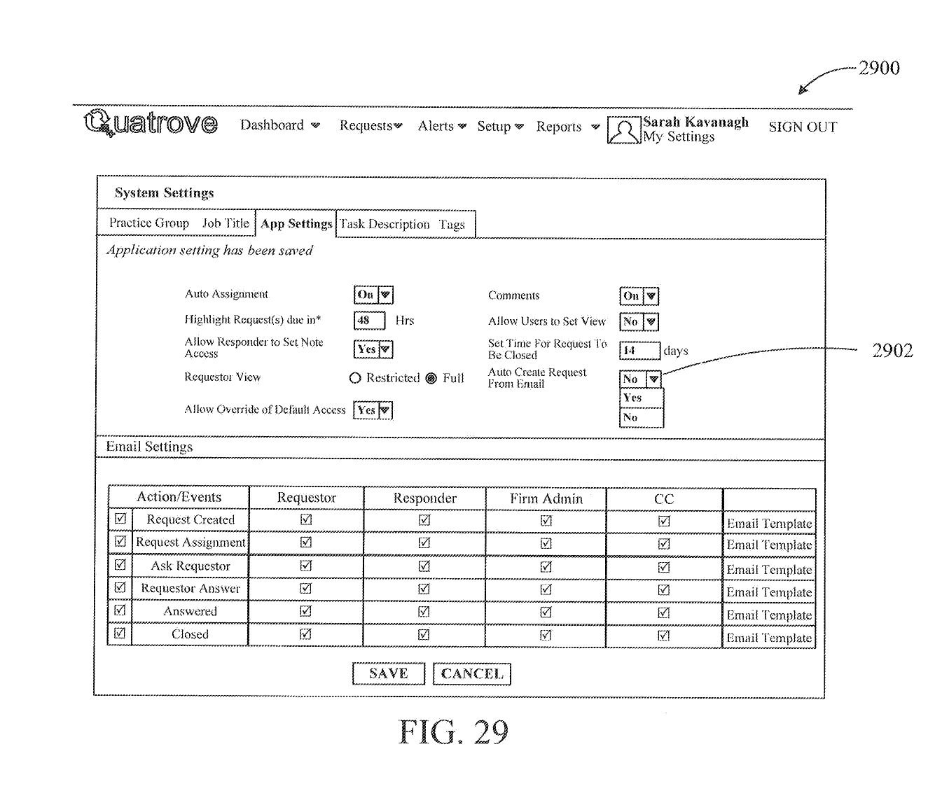

FIG. 29 illustrates an alternative example system settings interface 2900. Unless otherwise indicated, system settings interface 2900 may operate substantially similar to system settings interface 1400. Unlike system settings interface 1400 (shown in FIG. 14), system settings interface 2900 may include an auto create request from email menu 2902. In the example embodiment, the default selection in auto create request from email menu 2902 is “No”, and research requests 310 will not automatically be generated by sending an email to the designated address.

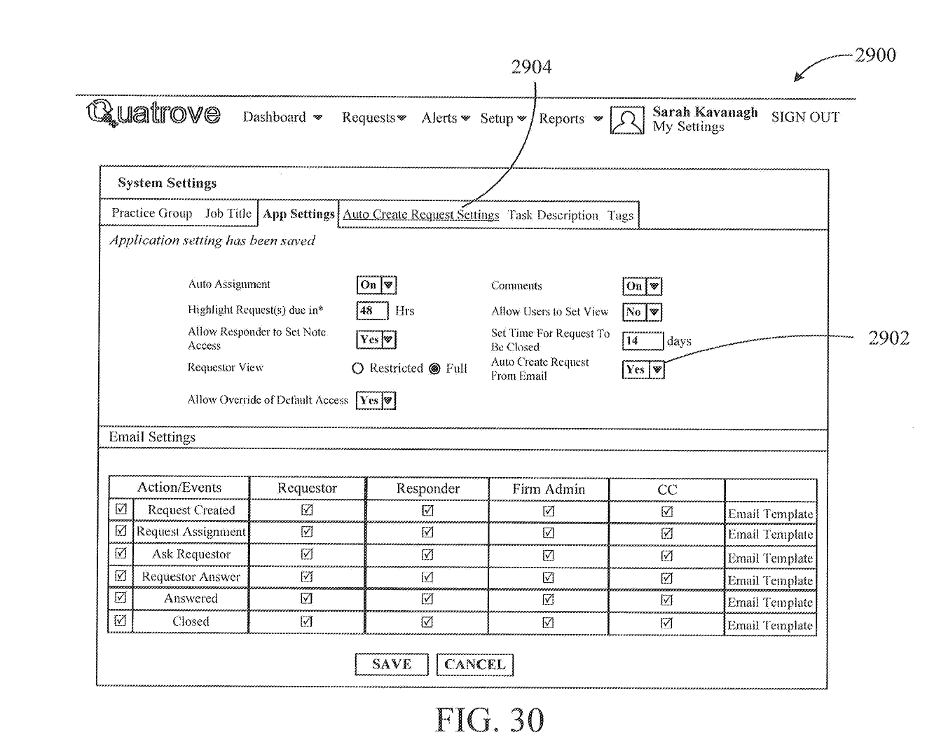

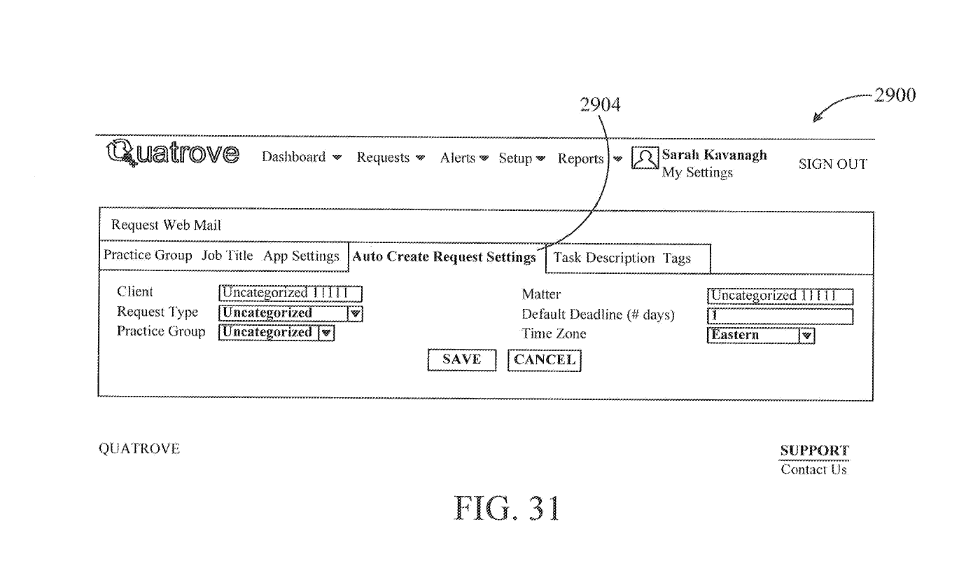

As shown in FIG. 30, when “Yes” is selected in auto create request from email menu 2902, an auto create request settings tab 2904 is displayed on system settings interface 2900. In FIG. 31, auto create request settings tab 2904 may be selected, enabling an administrator user 112 to modify a plurality of settings regarding generating research requests 310 from emails. In the example embodiment, user 112 can set a client, matter, request type, practice group, deadline, and/or time zone for requests 310 automatically generated from emails.

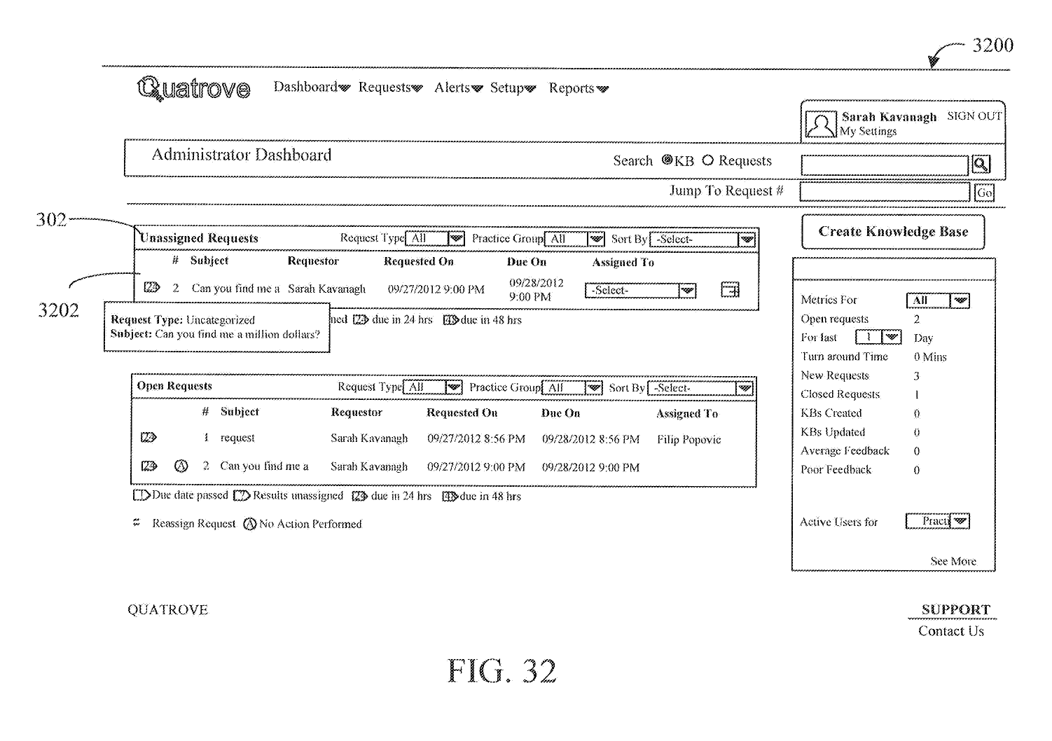

FIG. 32 illustrates an example administrator dashboard user interface 3200, similar to administrator dashboard user interface 300 (shown in FIG. 3). Unassigned requests list 302 of administrator dashboard user interface 3200 may include an automatically generated research request 3202. That is, with the auto create request from email option activated, when an email is sent to the designated email address, research request 3202 may be automatically generated and displayed on administrator dashboard user interface 3200. A confirmation email may also be sent to the sender of the generating email once research request 3202 has been created.

Research request 3202 may be generated in accordance with the settings selected in auto create request settings tab 2904 (shown in FIGS. 30 and 31). This may be pre-populated using the requestor's information in the research request management application such that the requestor only needs to enter the question or research request. In addition, incorrect information (e.g., an invalid client/matter number) can be prevented from being used in the request as this information may be checked by the research request management application before the question or research request is submitted. The research request management application may parse information in the generating email (e.g., sender (e.g., requestor, responder, cc'd personnel), subject, body (e.g. request description), job title, practice group, phone number, office location, timekeeper ID, email ID and/or other fields as determined and created by administrative users) to generate the research request 3202. For example, in the example embodiment, the research request management application may set the sender of the generating email as the requestor for research request 3202, and then may set the subject line of the generating email as the subject of research request 3202. In other embodiments, the research request management application may parse other information from the generating email to create research request 3202. By selecting automatically generated research request 3202 in administrator dashboard user interface 3200, administrator user 112 can assign research request 3202 to a responder, and update and/or modify other parameters of research request 3202 (e.g., subject, due date, client, matter, request type, practice group, time zone, etc.). Further, if permitted by administrator user 112, once research request 3202 has been assigned, the assigned responder user 112 can access the request 3202 from a responder dashboard interface, such as responder dashboard interface 2100 (shown in FIG. 21) and modify one or more parameters of research request 3202.

Enabling users to create research requests by sending an email to the designated email address may facilitate creating research requests efficiently and easily. As users can generate requests without logging into the research request management application, this may reduce the time needed to create new requests. This may be advantageous in today's economic climate where library and other staff levels are being reduced, yet demand for services on those reduced staff members is ever-increasing. Further, generating emails may be automatically displayed in the research request management application for all members of an associated responder team, which may increase the speed the responders become aware of requests and response times, which may enable responder teams to better meet 24/7/365 service-level expectations of their employers.

FIG. 33 illustrates an example request page where a request can be submitted. Different fields (e.g., request type, requestor, deadline, created for requestor by, client, matter, cc information, practice group, phone number, subject, attachment request description) can be entered and/or tracked. The field may be customized by an administrative user. This request page can be viewed only for users authorized to view the request pate (e.g. logged in users).

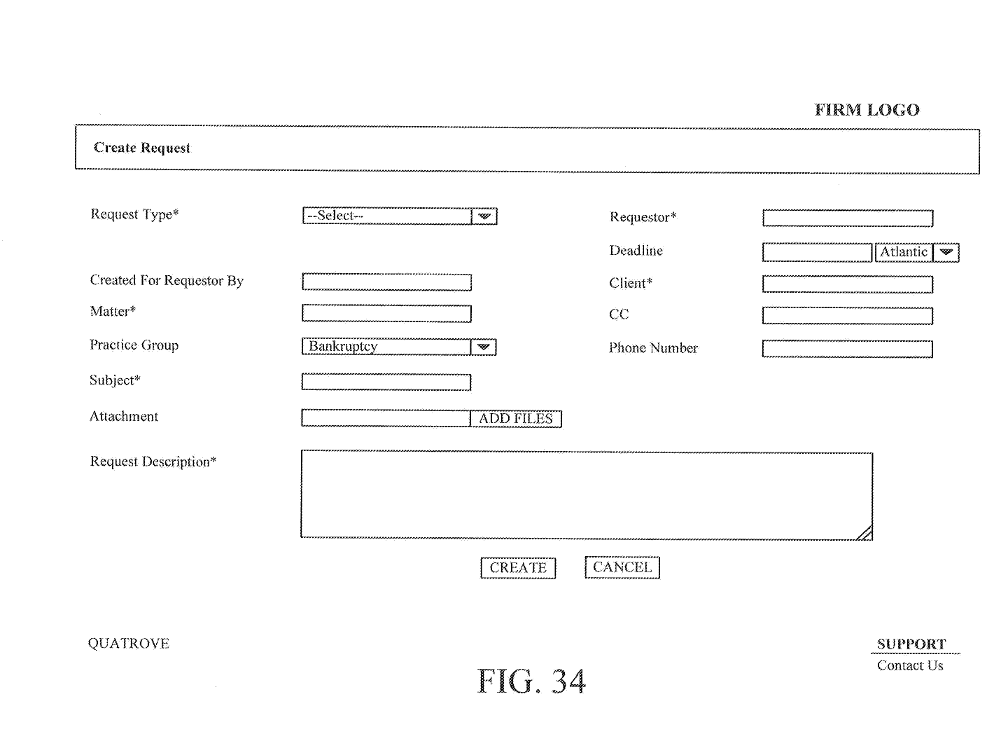

FIG. 34 is similar to FIG. 33, except that FIG. 34 illustrates a secure request page that can be accessible to anyone authorized to access the secure request page (e.g. a user who has a unique URL accessible to them using a security token). The unique URL may also serve as a mobile link for requestors to create a request without logging into the research request system 200. In this way, a user can remotely add information to a work request without having to access work request information. In some embodiments, no special encryption software or VPN setup is needed to access the application; only a browser and internet access are required. The secure request page may include the same fields as those illustrated in FIG. 33 and/or the secure request page may have customized fields. The secure request page may be platform neutral and accessible on any platform and via any web browser. Note that in some embodiments, a user may also simply sent an email to a designated email address, which email will automatically create or update the work record.

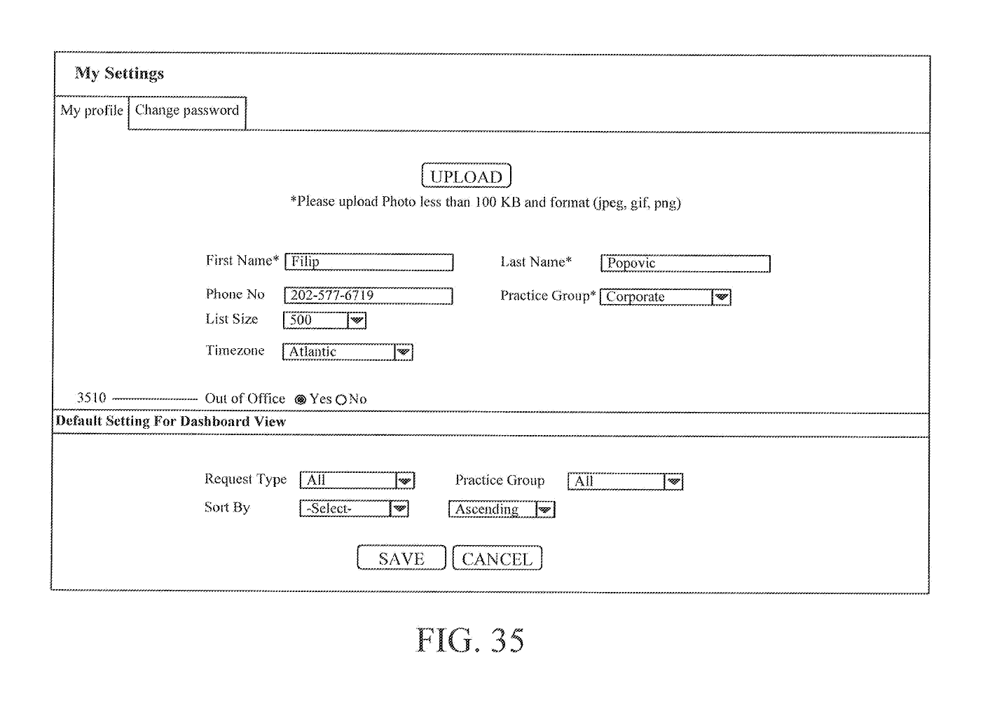

FIG. 35 is an example settings page. The setting page may provide a responder with the option of selecting if he or she is out of the office 3510. If the user selects yes, then the out-of-office feature will be turned on. The out-of-office feature may notify (e.g., via email or within the research request system 200) requestors when a responder is out of the office. In addition, responders may also be notified via email when a message has arrived from a requestor while that responder is out of the office. For example, when a responder selects the out-of-office feature, the administrators will know that person is out (and thus unavailable for research) because an icon will appear indicating this. In addition, if a responder has already started a project for a requestor, the requestor may receive correspondence indicating the researcher is out. If the requester needs help while the responder is out, the requestor may be given the opportunity to select a new researcher to help with the request or the requester may send a new request. In addition, the responder can also receive correspondence while the responder is out asking the responder to respond to the requester while out of the office.

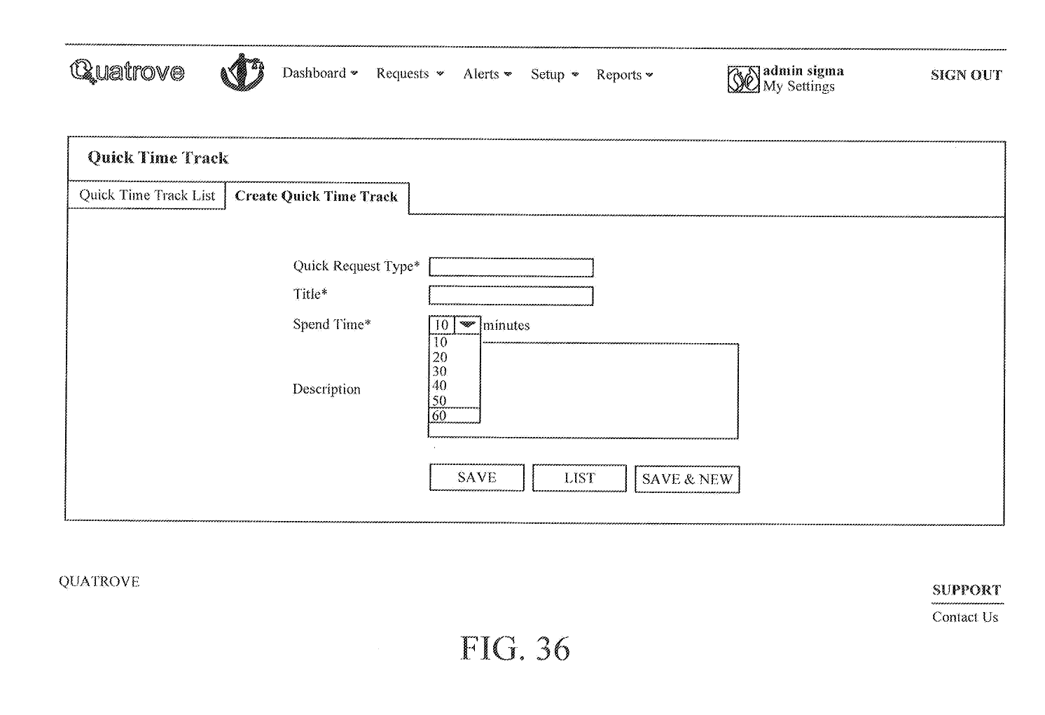

FIG. 36 illustrates a quick time track feature, where in one click, a user can enter the time spent on a specific task without having to associate the time to a specific client and matter. In this way, there is no need to associate a specific task to any request. In FIG. 36, a user can enter a quick request type, a title, a time interval, and a description to be associated with the time spent for that task. This quick time track feature may help a user easily add and account for time when the user is doing a task that does not require creating of a new request. A user can export this quick time track separately from time tied to requests and/or projects. In this way, more reporting of time may be realized, which may enable better time reporting and decision making related to a user's use of time This may give a more accurate view of how much time is being spent and what is being done by the team, which may allow for better informed management decisions. For example, if professional employees are being interrupted often for mundane tasks, the quick time track feature will record the interruptions and allow management to redirect those requests to appropriate responders (e.g., if mundane requests are going to a $450/hr person, they can be redirected to a non-billable person).

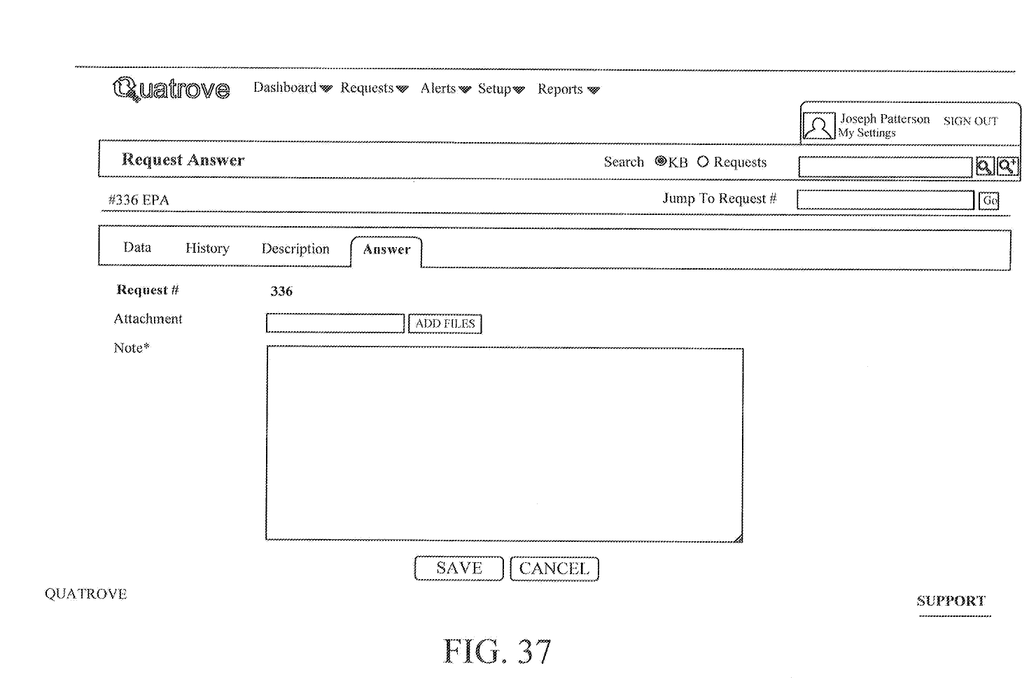

FIG. 37 illustrates an example request answer interface that may be used with the research request system shown in FIG. 2. The request number may be indicated, along with any attachments and notes.

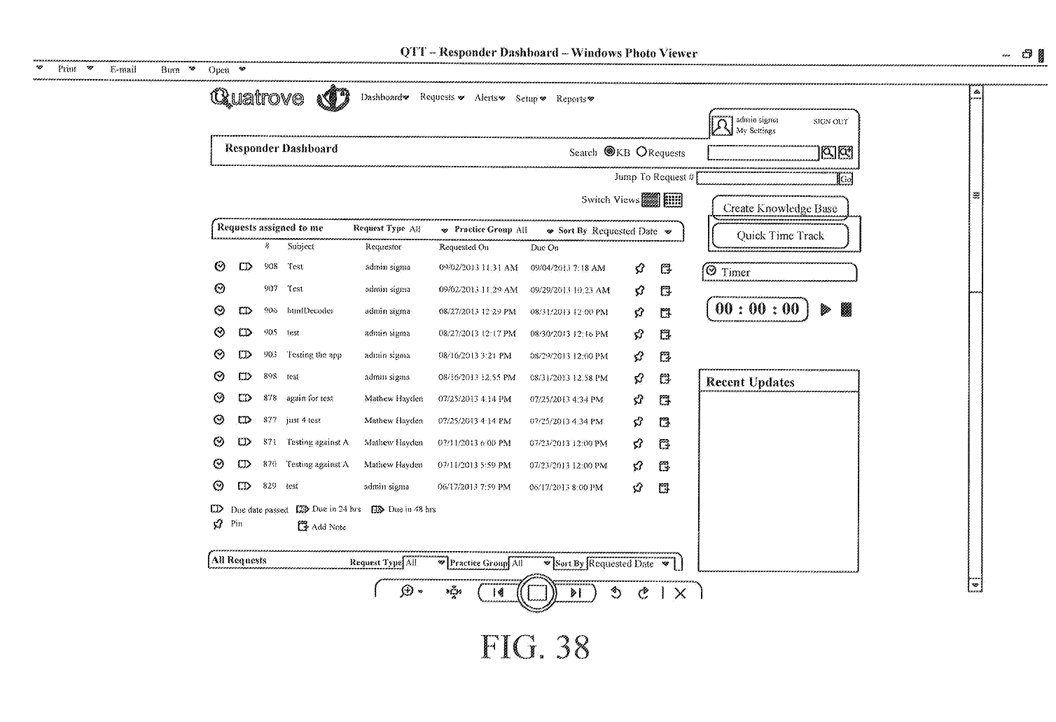

FIG. 38 illustrates an example responder dashboard interface illustrating a quick time track feature that may be used with the research request system shown in FIG. 2. A timer may be included that includes a pause and stop button. The pause button may be helpful to a user because the user may start and stop the project without creating a new project and/or time entry.

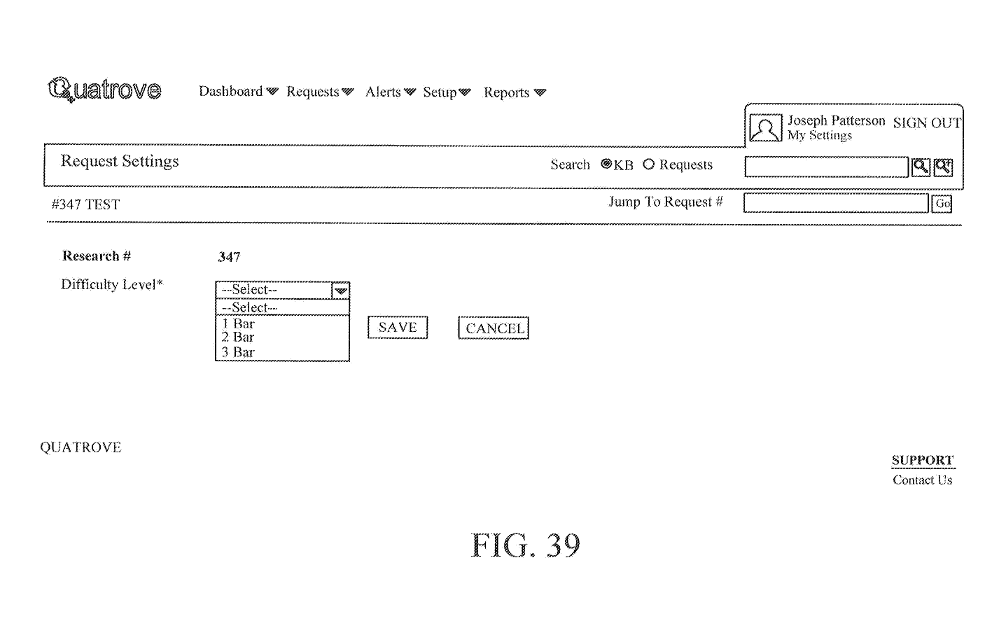

FIG. 39 illustrates an example request settings interface that may be used with the research request system shown in FIG. 2. A request number and the difficulty level of the request may be indicated. The difficulty of the request/project may be recorded so that accurate analysis (e.g. of work performance, team management, service level delivery, etc.) may be done.

The systems and methods described herein may facilitate managing (e.g., generating, tracking, completing) one or more research requests. Requests may be added to the research request system from any browser on any device with web access. The research requests can be organized into one or more knowledge bases, facilitating collaboration and efficient workflow of a research team. That is, the knowledge base may form a comprehensive database of shared knowledge including related research requests, notes, documents, etc. Accordingly, for future research requests, instead of starting from scratch, users can consult the appropriate knowledge base to easily and efficiently determine what has been accomplished already, enabling the user to recycle and reuse existing information for the task at hand. As users iteratively add to the knowledge base, the knowledge base may become more and more comprehensive. As such, the knowledge bases in the systems and methods described herein may facilitate capturing knowledge for an organization (such as a law firm) in an intuitive, accessible, and comprehensive format.

The systems and methods described herein may also provide an efficient and easy method to add data to a large, easily searched repository of “work already performed” that is beyond a final work product (e.g., it can keep track of research projects, whether or not they are used). The systems and methods described herein may capture strategy, underlying research performed, and work completed but not included in a final work product that has utility for future projects. Users may use the database/repository of “work already performed” because the search function is embedded in the workflow and work space (e.g., when a user select KB 2115 in FIG. 21, the user may be taken to a knowledge base creation interface such as the one in FIG. 5 or 6). Users will also have an incentive to reuse and/or recycle work already performed.

The systems and methods described herein also help restore face-to-face knowledge sharing that occurred before email became ingrained in the workplace. Mentoring and/or knowledge sharing can be better accomplished by creating experience and/or expertise databases that can be used for marketing and/or training within a firm. Previous efforts catalogue self-reported data that is rarely accurate. The systems and methods described herein help allow identification of experience and/or expertise by viewing users' actual work experience, providing a more accurate picture of experience and/or expertise.

The systems and methods described herein also provide “social” utility. For example, the dashboard can facilitate communication with users who have never met and are in different offices, countries and/or time zones. A challenge of employers today is how to maintain the camaraderie and morale of a team when none of the individuals have ever met or communicated much beyond a quick, project-related call. The dashboard passively communicates to the team what other responders are doing. Team members can easily provide or request support and assistance via chat, email and comments. This functionality may help create a teamwork atmosphere because team members can see what the rest of the team are doing.

The systems and methods described herein also provide information about what people need when and where they need it. For example, even though there are many layers, the recent updates space can be provided to alert anyone working to be aware of a request status change, new information related to a request, and/or arriving communications. In addition, a quick way to add information to a user's records and/or database may be provided. Information can be provided at any point with a shortcut developed to allow any user to send an email to research request system 200, and have that email attached to the project. For example, an email to tqsupport@topazresearch.com with “: #Request Number” in the subject line of the email may be sent, and that email (with any attachments) will attach in that record as a note.

Example computer readable media may include, without limitation, hard disk storage, optical drive/disk storage, removable disk storage, flash memory, non-volatile memory. ROM, EEPROM, random access memory (RAM), etc. By way of example and not limitation, computer readable media may comprise computer storage media and communication media. Computer storage media store information such as computer readable instructions, data structures, program modules or other data. Communication media typically embody computer readable instructions, data structures, program modules, or other data in a modulated data signal such as a carrier wave or other transport mechanism and include any information delivery media. Combinations of any of the above are also included within the scope of computer readable media.

Although described in connection with an example computing system, the methods and/or processes described herein may be employed with numerous other general purpose or special purpose computing system or configurations. Examples of computing systems include, but are not limited to, mobile computing devices, personal computers, server computers, hand-held or laptop devices, multiprocessor systems, gaming consoles, microprocessor-based systems, set top boxes, programmable consumer electronics, mobile telephones, network PCs, web servers, minicomputers, mainframe computers, distributed computing environments that include any of the above systems or devices, and the like.

Embodiments of the present disclosure may be described in the general context of computer-executable instructions, such as program modules, executed by one or more computers or other devices. The computer-executable instructions may be organized into one or more computer-executable components or medias. Generally, program instructions include, but are not limited to, routines, programs, objects, components, and data structures that perform particular tasks or implement particular abstract data types. Aspects of the present disclosure may be implemented with any number and organization of such components or medias. For example, aspects of the present disclosure are not limited to the specific computer-executable instructions or the specific components or medias illustrated in the figures and described herein. Other embodiments may include different computer-executable instructions or components having more or less functionality than illustrated and described herein.

One or more aspects of the present disclosure transform a general-purpose computing device into a special-purpose computing device when configured to execute the instructions described herein.

Moreover, the order of execution or performance of the operations in embodiments illustrated and described herein is not essential, unless otherwise specified. That is, the operations may be performed in any order, unless otherwise specified, and embodiments of the invention may include additional or fewer operations than those disclosed herein. For example, it is contemplated that executing or performing a particular operation before, contemporaneously with, or after another operation is within the scope of aspects of the invention.

When introducing elements of aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

Having described aspects of the invention in detail, it will be apparent that modifications and variations are possible without departing from the scope of the present disclosure as defined in the appended claims. As various changes could be made in the above constructions, products, and methods without departing from the scope of the present disclosure, it is intended that all matter contained in the above description and shown in the accompanying drawings shall be interpreted as illustrative and not in a limiting sense.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. Thus, the present embodiments should not be limited by any of the above-described embodiments.

In addition, it should be understood that any figures which highlight the functionality and advantages are presented for example purposes only. The disclosed methodology and system are each sufficiently flexible and configurable such that they may be utilized in ways other than that shown.

Further, the purpose of any Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. An Abstract of the Disclosure is not intended to be limiting as to the scope of the present invention in any way.

Although the term “at least one” may often be used in the specification, claims and drawings, the terms “a”, “an”, “the”, “said”, etc. also signify “at least one” or “the at least one” in the specification, claims and drawings.

Additionally, the term “comprising” or similar terms in the specification, claims and drawings should be interpreted as meaning “including, but not limited to.”

Finally, it is the applicant's intent that only claims that include the express language “means for” or “step for” be interpreted under 35 U.S.C. 212, paragraph 6. Claims that do not expressly include the phrase “means for” or “step for” are not to be interpreted under 35 U.S.C. 212, paragraph 6.

What is claimed is:

1. A computer-based method for managing work requests using a computing device coupled to a memory device, said method comprising:
generating, at the computing device, a work request based on a user input;
storing, in the memory device, an assignment of the work request to a responder based on the user input; and
tracking and storing, at the computing device, progress of the work request such that the progress of stored work requests may be reviewed.

2. The method of claim 1, wherein the work request is a research request.

3. The method of claim 1, wherein the research request includes an identification number, a subject of the request, and a requestor name.

4. The method of claim 1, further comprising storing, in the memory device, an association between the work request and the knowledge base, wherein the association is triggered by the user.

5. The method of claim 1, further comprising generating a knowledge base comprising:
defining a subject for the knowledge base;
associating a group or category with the knowledge base;
associating at least one tag with the knowledge base; or
setting an access level for the knowledge base; or
any combination thereof.

6. The method of claim 1, wherein generating the work request comprises associating the work request with a request type selected from a list of available request types.

7. The method of claim 1, wherein customizable email notifications are sent to users to inform a user of the progress of the work request.

8. The method of claim 1, further comprising generating, at the computing device, at least one time record indicative of an amount of time spent by the responder in completing the work request.

9. The method of claim 8, wherein the at least one time record is kept using a stop and a pause option.

10. The method of claim 8, wherein the at least one time record is kept and exported to incorporate into a billing system and/or another time tracking system.

11. The method of claim 1, wherein generating a work request comprises automatically generating a work request in response to an email sent by the user to a designated email address.

12. The method of claim 5, further comprising:
searching work requests and the knowledge base;
accessing work request information and knowledge base information; and
creating a report analyzing the searching and presenting the work request information and the knowledge base information.

13. The method of claim 1, wherein correspondence related to the work request is stored as part of the progress of the work request.

14. The method of claim 1, further comprising automatically adding a record to the progress of the work request in response to an email sent by the user to a designated email address.

15. The method of claim 1, further comprising enabling a user to remotely add information to a work request and/or the knowledge base without having to access work request information or the knowledge base.

16. A computing device for use in managing at least one research request, said computing device comprising:
an input device configured to receive a user input;
a processing device coupled to said input device and configured for:
generating, at the computing device, a work request based on a user input;
storing, in the memory device, an assignment of the work request to a responder based on the user input; and
tracking and storing, at the computing device, progress of the work request such that the progress of stored work requests may be reviewed.

17. The system of claim 16, wherein the work request is a research request.

18. The system of claim 16, wherein the research request includes an identification number, a subject of the request, and a requestor name.

19. The system of claim 16, wherein the processing device is further configured for storing, in the memory device, an association between the work request and the knowledge base, wherein the association is triggered by the user.

20. The system of claim 16, further comprising generating a knowledge base comprising at least one of:
defining a subject for the knowledge base;
associating a group or category with the knowledge base;
associating at least one tag with the knowledge base; or
setting an access level for the knowledge base; or
any combination thereof.

21. The system of claim 16, wherein generating the work request comprises associating the work request with a request type selected from a list of available request types.

22. The system of claim 16, wherein customizable email notifications are sent to users to inform a user of the progress of the work request.

23. The system of claim 16, further comprising generating, at the computing device, at least one time record indicative of an amount of time spent by the responder in completing the work request.

24. The system of claim 23, wherein the at least one time record is kept using a stop and a pause option.

25. The system of claim 23, wherein the at least one time record is kept and exported to incorporate into a billing system and/or another time tracking system.

26. The system of claim 16, wherein generating a work request comprises automatically generating a work request in response to an email sent by the user to a designated email address.

27. The system of claim 20, further comprising:
searching work requests and the knowledge base;
accessing work request information and knowledge base information; and
creating a report analyzing the searching and presenting the work request information and the knowledge base information.

28. The system of claim 16, wherein correspondence related to the work request is stored as part of the progress of the work request.

29. The system of claim 16, further comprising automatically adding a record to the progress of the work request in response to an email sent by the user to a designated email address.

30. The system of claim 16, further comprising enabling a user to remotely add information to a work request and/or the knowledge base without having to access work request information or the knowledge base.
